(19) United States
(12) Patent Application Publication
(10) Pub. No.: US 2002/0120504 A1
(43) Pub. Date: Aug. 29, 2002

(54) Computerized system and method for increasing the effectiveness of advertising

(75) Inventors: Alan D. Gould, New York, NY (US); Kenneth S. Orkin, New York, NY (US); Trevor Chung, New York, NY (US); Cheryl Idell, Hewlett Neck, NY (US)

Correspondence Address: GREENBERG-TRAURIG, 1750 TYSONS BOULEVARD, 12TH FLOOR, MCLEAN, VA, 22102, US

(73) Assignee: Intermedia Advertising Group, New York, NY

(21) Appl. No.: 09/917,792

(22) Filed: Jul. 31, 2001

Related U.S. Application Data
(60) Provisional application No. 60/221,776, filed on Jul. 31, 2000.

(51) Int. Cl. G06F 17/60

(52) U.S. Cl. 705/14

(57) ABSTRACT

Disclosed is a system and method for conducting an incentivized trivia contest to increase the effectiveness of advertising which includes a software information system that collects and analyzes data on the effectiveness of ads during the programs in which the ads are aired. The system can be used to report data on recall, understanding, likeability and other key performance measures to advertisers and other clients, via a web based delivery system. A first set of trivia questions relating to advertising and a second set of trivia questions relating to content are stored in the system. The first and second sets of trivia questions are associated with a broadcast of advertising along with content. A subset of the first and second trivia questions are selected for transmission to a member. The member's responses are received and points are awarded for correct answers. Incentives are provided to members based upon points awarded.

This application claims the benefit of U.S. Provisional Patent Application Serial No. 60/221,776 filed Jul. 31, 2000, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

This application includes a microfiche appendix having 4053 frames and 42 fiche. The microfiche includes source code which is hereby incorporated into and made part of this specification.

### FIELD OF THE INVENTION

The present invention relates in general to the field of software and hardware systems for advertising, and in particular to a novel system and method for improving the effectiveness of advertising and other broadcasts.

### BACKGROUND OF THE INVENTION

Advertisers spend more than $50 billion annually to reach consumers via television and yet cannot measure the effectiveness of their ads in the context of the programs in which they are aired. Currently, many advertisers pre-test advertisements before they are placed on the air through the use of “focus groups” and other research techniques and post-test advertisements after the ads have run, primarily through the use of telephone surveys. On occasion, advertisers will test the effectiveness of their ads on a continual basis via telephone surveys to gauge ongoing awareness of their advertising campaign. This method is not widely used because it is cost prohibitive to conduct research on a continuous basis for all the ads running on all shows.

Yet the need for accurate, continuous data on the performance of ads has never been more important to television advertisers because of a substantial decline in attentiveness to television advertising and the substantial increase in the cost of television advertising. Twenty-five years ago, three broadcast networks dominated the television industry. Today, consumers have an array of choices—additional networks, niche cable stations, movie channels, satellite systems, and new forms of home entertainment such as electronic games and the Internet. Further complicating the problem for advertisers, audiences use multiple entertainment and information media at the same time (TV, internet, magazines, electronic games)—viewers are doing something else while they are “watching” TV.

Though advertisers spend $50 billion annually to reach consumers via television, 50% of the television audience changes the channel, leaves the room, or focuses on something other than the television set during the commercial break —they never see the advertising. Further, only 20% of those who see a television ad, if prompted, can recall it. Less than 10% understand an ad's message.

Because audiences don't pay attention to (or never see) the ads, the effective cost of reaching consumers is approximately 20 times higher than the network reported CPM (Cost Per Thousand) rate. This has significant financial implications for advertisers, and represents a substantial opportunity in the marketplace to increase efficiency by supplying them with organized data on the performance of their ads.

### SUMMARY OF THE INVENTION

In a preferred embodiment, the invention provides a system and method for conducting an incentivized trivia contest to increase the effectiveness of advertising which includes a software information system that collects and analyzes data on the effectiveness of ads during the programs in which the ads are aired. The system can be used to report data on recall, understanding, likeability and other key performance measures to advertisers and other clients, via a web based delivery system. A first set of trivia questions relating to advertising and a second set of trivia questions relating to content are stored in the system. The first and second sets of trivia questions are associated with a broadcast of advertising along with content. A subset of the first and second trivia questions are selected for transmission to a member. The member's responses are received and points are awarded for correct answers. Incentives are provided to members based upon points awarded.

The data provided by the system and method of the invention in its preferred embodiment allows advertisers to compare performance by show, genre of show, and network, thereby allowing advertisers to re-allocate resources and ad inventory such that ads air where they are most effective in reaching the target audience.

The data provided by the system also allows advertisers to understand the performance of product placement advertising—advertising that is integrated into the content of a program itself, rather than appearing as a piece of distinct content during program breaks. Because of declining attention rates, and the advent of new technologies which allow viewers to edit out advertisements entirely from the programs they watch, this form of advertising is becoming increasingly important. Within the advertising and television industries, no system, standards or form of measurement currently exists for providing performance data on product placement advertising.

At the same time, the data provided by the system allows television networks and program producers to evaluate audience reaction to programming content, including plotlines, characters, musical themes, and other creative elements.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagramatic view illustrating certain broad principles of the invention in accordance with a preferred embodiment.

FIG. 2 is an entity relationship diagram showing an example of an architecture which may be used to practice the consumer site portion of the system of the invention.

FIG. 3 is an entity relationship diagram illustrating the architecture of the TV Listings and Flighting Schedule subject area in accordance with a preferred embodiment of the invention.

FIG. 4 is a block diagram showing an example of atomic-level questions.

FIG. 5 is a block diagram showing an example of an advertising question “bin” process.

FIG. 6 is an entity relationship diagram showing an example of the survey and questions subtopic data model in accordance with a preferred embodiment of the invention.

FIG. 7 is an entity relationship diagram showing an example of the architecture of the members' subtopic data model.

FIG. 8 is an entity relationship diagram illustrating a subtopic data model for community events.

FIG. 9 is an entity relationship diagram showing an example of a rewards subtopic data model in accordance with a preferred embodiment of the invention.

FIG. 10 is an entity relationship diagram illustrating the preferred overall entity relationship model of the consumer site of the invention.

FIG. 11 is an entity relationship diagram illustrating a client product domain structure data model in accordance with a preferred embodiment of the invention.

FIG. 12 is an entity relationship diagram illustrating the client domain subject area.

FIGS. 13a and 13b show an entity relationship diagram illustrating a logical model for the TVListings subject area.

FIGS. 14a and 14b show an entity relationship diagram illustrating the details of the data model for the Question and Survey Subject Area.

FIGS. 15a and 15b show an entity relationship diagram illustrating the details of the data model for the Member Subject Area.

FIGS. 16a and 16b show an entity relationship diagram illustrating the details of the data model for the Rewards Catalog Subject Area.

FIGS. 17a and 17b show an entity relationship diagram illustrating the details of the data model of the Advertiser Domain Subject Area.

FIG. 18 shows an entity relationship diagram illustrating the details of the data model of the Client Data Warehouse Subject Area.

### DETAILED DESCRIPTION OF THE PREFERRED EMBODIMENT

Reference will now be made in detail to the preferred embodiments of the present invention, examples of which are illustrated in the accompanying drawings.

The system and method of the invention provides an information solution for television advertisers, media and ad agencies, content creators, and broadcasters. A rewards program model is applied to television, combining entertainment with rewards, sweepstakes, and other forms of financial compensation to build a large and inexpensive research panel of television viewers. This research panel delivers a rich database of information, which is preferably refreshed daily, about the effectiveness of television advertising campaigns and programming content. It will be recognized by those skilled in the database may be refreshed hourly, every minute, in real time, etc., without departing from the spirit of the invention. By virtue of the key marketing components of the model and the incentives inherent in the system, two additional benefits are provided: (1) it strengthens the impact of individual ads by extending selected ad campaigns to the Internet, and (2) it provides television networks with a unique tool to decrease channel surfing, increase viewer loyalty and to build audiences for new programming content

Viewers are compensated for watching television and incentivized to provide data on their viewing habits. In accordance with one aspect of the invention, viewers access the system via a web site after watching a television show and the commercials and answer questions about the show and the ads. The same principles set forth herein with respect to the preferred embodiment may be applied to provide a system and method which utilizes other communications mediums and devices, such as wireless devices, set top boxes, PDAs, telephone, Interactive Voice Responder (IVR), etc.

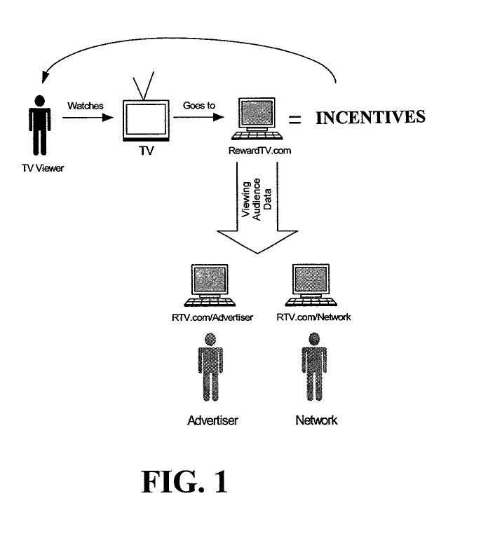

As is illustrated in FIG. 1, either during or after viewing a television show, a viewer logs onto the consumer section of a web server of the invention within a predetermined period of time, and answers a series of trivia game type questions about the show and ads. Such ads may be conventional commercials or, e.g., “product placement” type ads in which a product appears within the content of the programming. Viewers who answer these questions may receive proprietary “currency,” which they can redeem for goods, services, and prizes.

In accordance with one embodiment of the invention, after watching a show, viewers are given, initially, up to 24 hours to register their opinions by logging on to the web server and answering a series of questions. The system assigns credit to viewers for completing this question set and answering questions correctly. The system may also allow members to answer questions on a variety of platforms—including wireless and interactive TV. In this respect, a “member” may be a TV watcher who registers on the website associated with the system.

The system of the invention aggregates and analyzes the data provided by the users of the web site and provides the results to clients. In this respect, a “client” is, e.g., an entity or individual tracking off-line advertisement success through the system. Clients may also be networks, media companies, and other entities in the industry which are interested in the effectiveness of advertising or data on attentiveness, recall, message understanding and likeability of ads or content. Clients may also be classified by their account types, e.g., users or administrators. This breakdown may specify what type of security access they have in terms of information.

The overall system of the invention is preferably divided into two primary areas, the consumer site and the client site. The consumer site is used to capture and maintain member information. Within this site the member has the ability, for example, to view TV listings, view TV content, view their account balance, view their show level statistics, view and redeem against a rewards catalog and to partake in trivia-based surveys on TV programs. This surveying component ties several areas together in order to present TV related trivia questions to the member. More importantly, the survey tool provides a means for automated marking of surveys. Surveys tie the advertiser's advertisements, TV listings, flighting schedule and members together to produce data related to television advertising and programming effectiveness.

The information captured from the consumer site is provided to a trendreporter component for aggregation and analysis. The trendreporter is the data warehouse associated with the client site that allows clients to view and analyze advertising and programming effectiveness. This research tool provides clients with a web-based method to measure the effectiveness of their commercials on a nightly basis, in the context of the programming and the other advertising. The system of the invention gathers and analyzes data on, e.g., attentiveness, recall, message understanding and likeability, and preferably provides that information to clients on a daily basis—providing a richly detailed picture of the impact of each advertisement at the time it is shown as well as an entire campaign. The trendreporter component preferably quantifies changes in audience size and delivers performance data and analysis, giving advertising clients tools to reallocate their ad mix to support the best performing ads and shows and to negotiate ad rates based on actual ad effectiveness. The system and method of the invention provides improved speed of reporting, large sample size, and ability to repeat (and therefore refine) sampling techniques.

The invention is preferably configured to provide great flexibility in data reporting. Senior marketing executives who need fast and simple, summarized results can use the trendreporter component to analyze the performance of their complete national television budget and view digitized versions of the ads that aired. Brand managers, media planners and media buyers can use the resulting detailed data about the performance of individual shows and ads to build more effective media campaigns for their clients.

Consumer Site Technical Overview

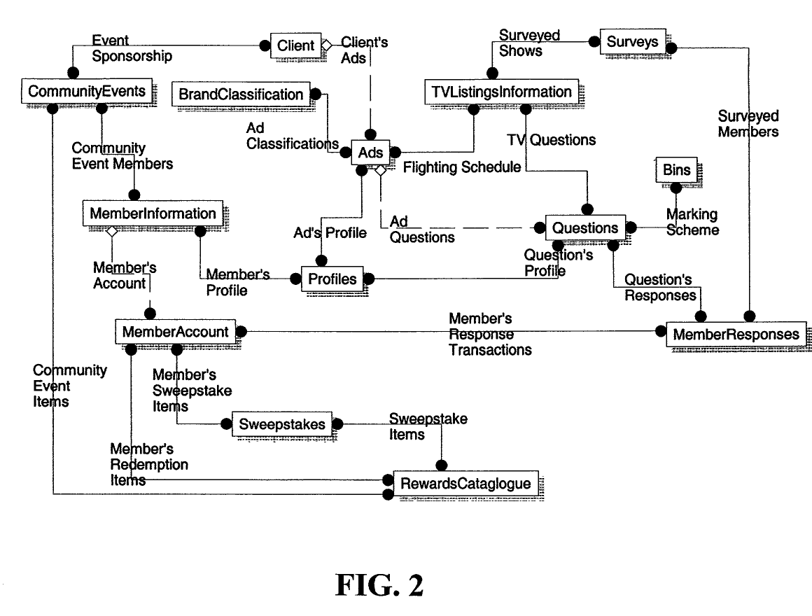

FIG. 2 is an entity relationship diagram showing an example of an architecture which may be used to practice the consumer site portion of the system of the invention. The overall consumer site can be broken down into several areas that, when integrated, provide clients with ad effectiveness information along with competitive analysis. Each is discussed in further detail below.

Clients entities—client and their brand classification structure.

Ads entities—Includes ads of existing and potential clients.

TV Listings and Advertisements entities—Includes TV listings and flighting schedule.

Client Domain Structure—Includes the advertiser's product and ads.

Survey entities—Includes trivia questions about the shows and questions.

Question entities—Various questions that can be potentially asked to the members. This includes show and ad related questions.

Member entities—Includes the member's demographics, surveys, account balance, reward catalogue items, and redemption history.

Member Response entities—Details the member responses to survey questions.

Rewards entities—Includes the rewards catalog.

Sweepstake entities—Includes the various sweepstakes offerings.

Community Events entities—Includes events for which groups of members play as a team to compete, for example, for prizes.

TV Listings Technical Overview

The TV listings information is used to maintain relationships between TV programs, broadcasters, and the broadcaster's program schedule. The system preferably provides members with access to the nation's TV listings and entertainment content stories. The information is also used by the system when building surveys and maintaining the broadcast stations' advertisement (flighting) schedule.

TV listings preferably has a two-level recursive structure; the first level maintains the shows, movies, and sporting events; second level is optional and maintains the overall show details for the TV series. The second level is applicable only when the first level is an episode of a show. This structure allows the system to maintain a list of episodes over the history of a television series. By maintaining the individual episodes, questions can be written and associated with that episode, allowing the growth of questions over the entire life (syndication) of a show.

In general, questions are associated with episodes, movies or sporting events and each individual show can have any number of questions.

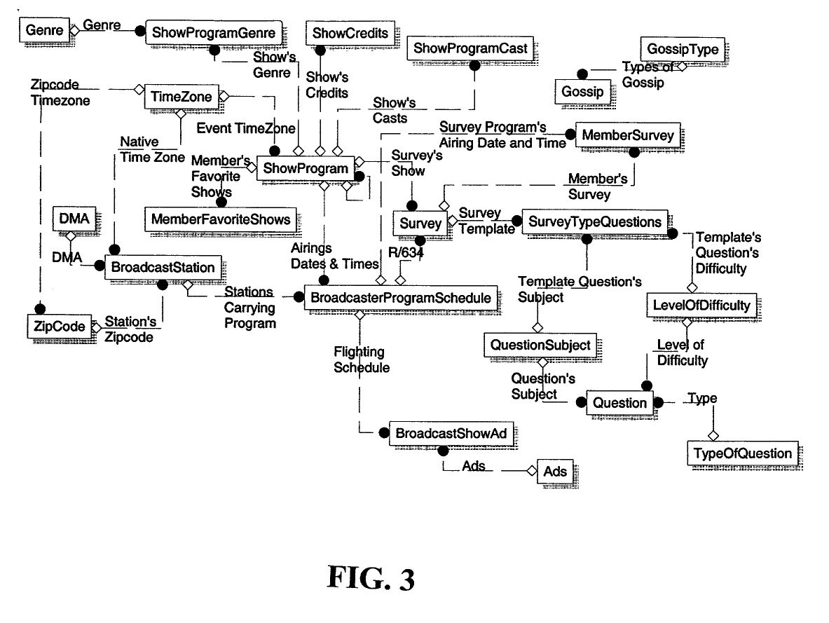

FIG. 3 shows an entity relationship diagram illustrating the architecture of the TV Listings and Flighting Schedule subject area in accordance with a preferred embodiment of the invention. In the figure, the ShowProgramGenre, ShowCredits, ShowProgramCast, Gossip, ShowProgram, BroadcastStation, BroadcasterProgragmSchedule and BroadcastShowAd entities are TV listings and Flighting Schedules tables; the “Question” entity is a subset of the Questions tables; the MemberFavoriteShows entity is a subset of members' tables; the Survey and SurveyTypeQuestions entities are Surveys tables; the MemberSurvey entity is a subset of the member's responses; the Ads entity is a Clients domain structure table; the Genre, GossipType, TimeZone, DMA, ZipCode, QuestionSubject, LevelOfDifficulty and TypeOFQuestion entities are a subset of code tables.

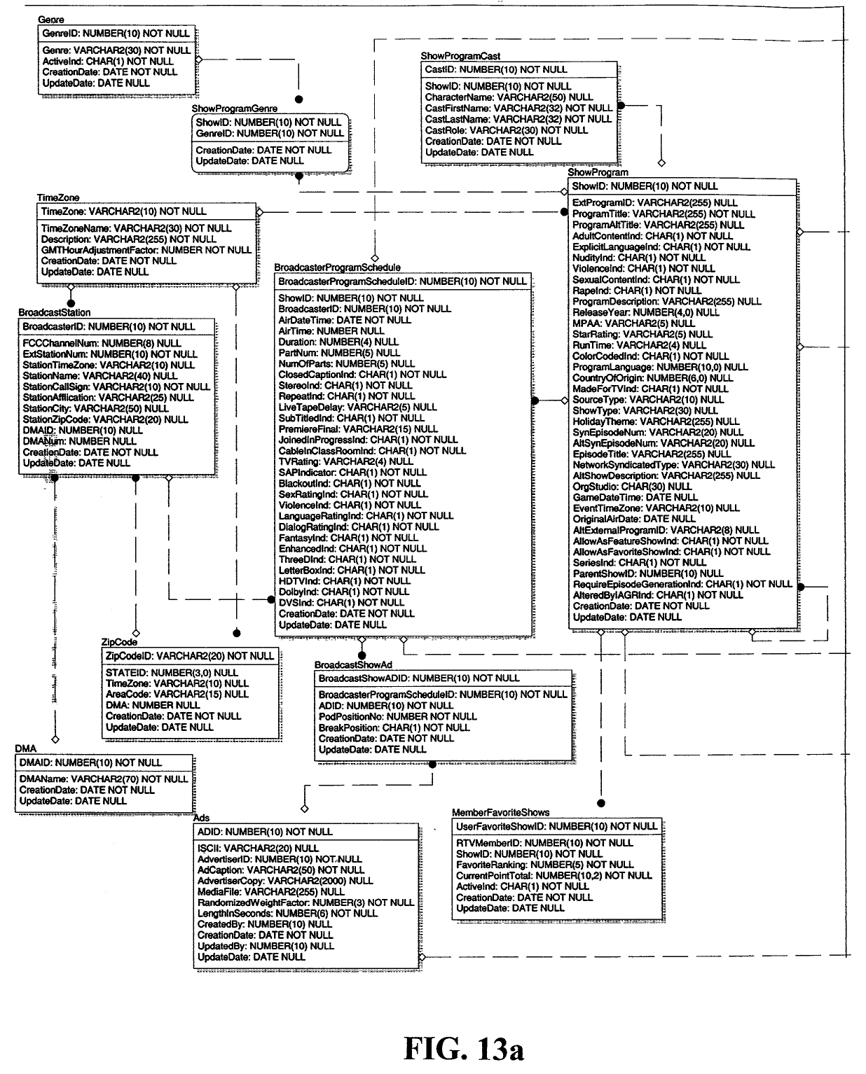

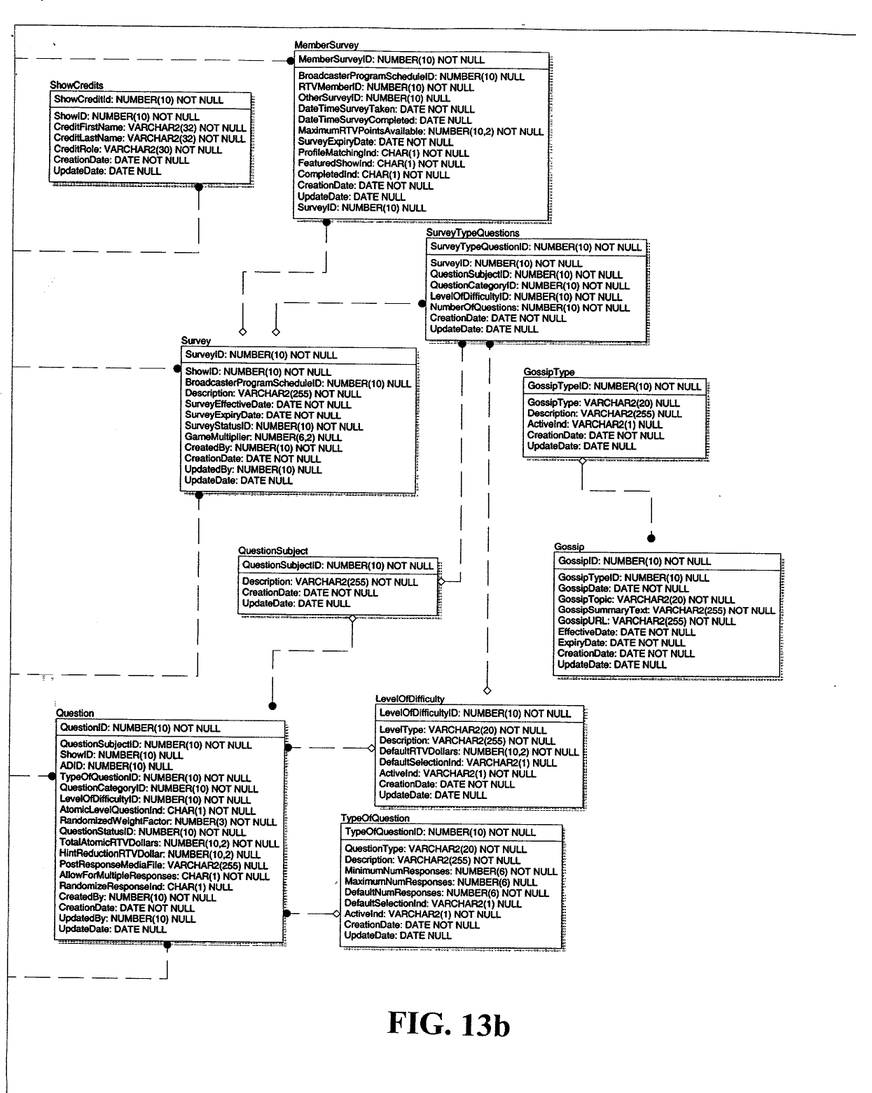

Refer to FIGS. 13a and 13b, which show the detail of the data model of the TV Listings Subject Area.

Survey Questions Technical Overview

The survey section of the consumer site is preferably broken down into two separate parts: (1) atomic-level questions and (2) survey template.

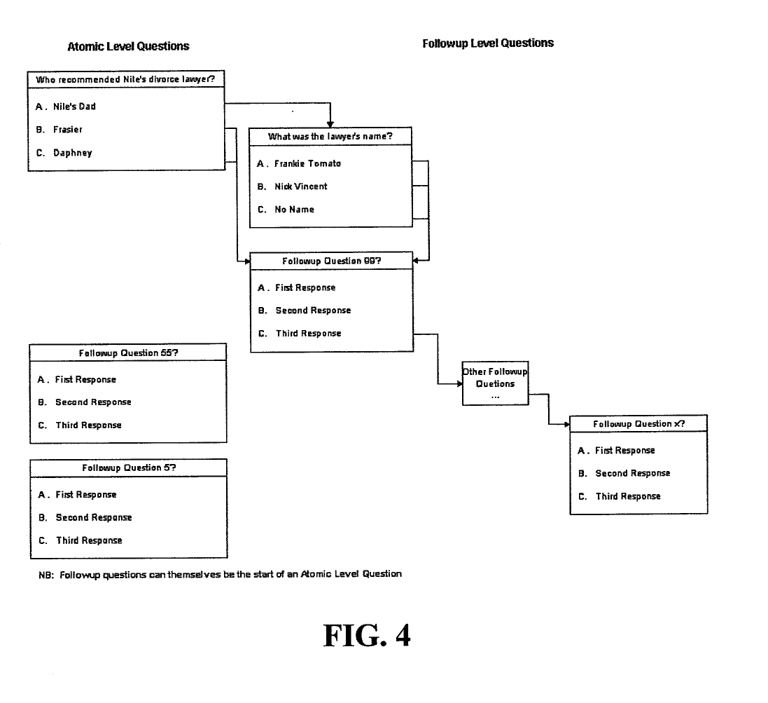

Questions may be classed into three subject areas: (1) Show-related questions, (2) Advertisement related questions, and (3) Other related questions. Each question is made-up of a question and its possible responses. In turn, responses to a question can invoke zero or more follow-up questions in a recursive manner. Ultimately, a set of questions is assembled into an ‘atomic’ question. It's these atomic questions that a Member is first presented with when they take part in a particular survey. In essence, an ‘atomic’ question is the first question in a series of questions. Atomic questions decompose to form a complete question; one that has no further questions. The questions are internationalized to provide questions and responses in any number of languages. FIG. 4 shows an example of atomic-level questions.

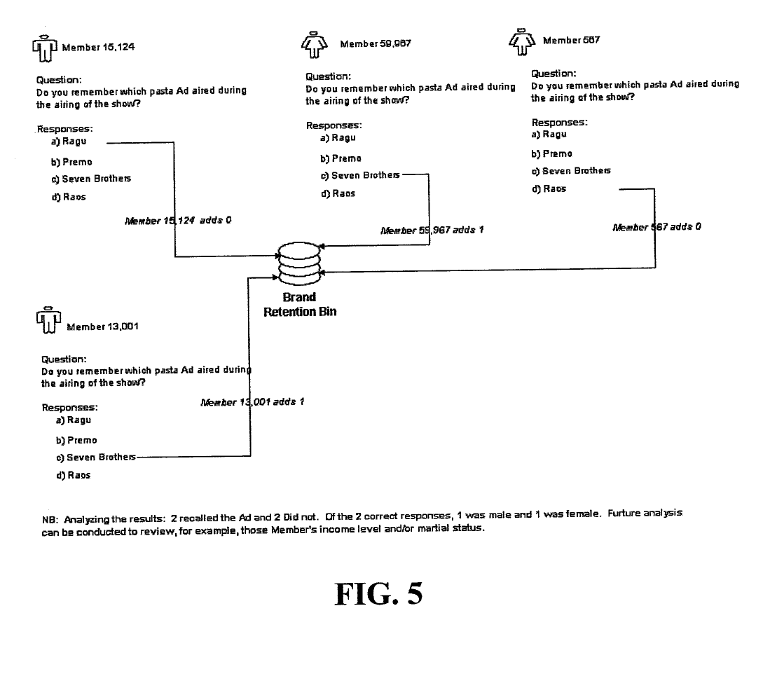

One architectural feature of the question administration toolset in its preferred embodiment is that it provides the survey creators with the ability to ‘mark’ a question. In essence, the survey creator indicates, for each question's response, a “bin” and the amount, or value that is added to this bin if the Member selects that response. These “bins” include what the Advertisers and other Clients ultimately receive in aggregated form. FIG. 5 shows an example of how this advertising question “bin” process works.

The bin system is extremely flexible and adaptable. Any number of bins can be associated with each question and subsequently each response within a question. During the creation of a question, an administrator (e.g., a person responsible for data entry, product management, and content rotation in the system) indicates, using the list of potential bins, the ones that apply. Within each response to a question, the administrator identifies, from that list of bins, what value(s) to add to those bins. Generally this value is 1. However, to provide flexibility, any numeric value can be used. For example, a question can be defined to test for likeability. This question may have 4 responses: Really liked, Liked, Not Liked, and Disliked having bin values 3,2,1, and 0 respectfully. The individual values can be aggregated in any number of ways to provide, for example, an advertiser with data that demonstrates how effective their ads have been or to provide a network or media client with data that demonstrates the likeability of its content Each entry added to the bin may include, e.g., the following information:

MemberID—Identifies the entry to a specific member

Value—Identifies that value added to the bin

Num Hints requested—Identifies whether the Member was provided with a hint

Show Confidence Factor—Identifies the percentage of show related questions that the Member correctly answered during the survey

Ad Confidence Factor—Identifies the percentage of ad related questions that the Member correctly answered during the survey

Profile Matching Indicator—Indicates whether the question was asked to qualified Member

Time Spent Responding—Indicates the estimated time the Member took to answer the question

The member's unique personal information (e.g., names, e-mail address, social security number, credit card information) is preferably removed before the information is aggregated and transferred to the data warehouse to protect the members' privacy. Starting with the above information, Clients can be provided with answers such as “How many people identified my Ad?” “How many required hints?” and “How many, even with a hint, didn't understand the message?” Taken further, analysis can be conducted to take into account demographics such as age, sex, martial status and income level.

The classes of questions, for the most part, function identically with one major difference; show-related questions relate back to a specific show program; ad-related questions relate back to a specific client's advertisement; and other related questions are not dependent on specific show or advertisement issues. The core of the tool allows for a flexible survey creation mechanism. The system is preferably designed to allow for other types of questions that are not specific to a show or an ad. The survey tool component of the system and method of the invention can also be utilized to create additional surveys for Clients.

Bins are associated with question responses and questions can be associated with advertisement, show, or other related topics. Taken with the domain structure and its access control right, the system can be used to provide analysis of ads to the authorized staff using the client's own domain structure.

Survey Technical Overview

Generally within the research industry, surveys are created listing the actual questions that will be asked. While the system and method of the invention may be configured to handle these traditional surveying methods, it preferably uses a more robust approach whereby surveys can also function more as a template than an actual survey with a list of questions. In accordance with this feature, an administrator creates processing rules when he defines a survey. The template surveys in accordance with this feature differ from a conventional list of specific questions in several ways. Firstly, they may be used to present to members a subset of randomly selected questions. Secondly, only at the time a member elects to answer a survey does the system select which set of ad questions to ask the member. When a Member indicates which program, and thus which broadcaster and time of airing, the system can determine which ad aired during a program. Thirdly, using processing rules, the survey creator can indicate a dynamic permutation of questions to ask the member. When creating a survey, the administrator can define the number of show content questions and advertisement related content question that will be asked to the Member. In addition, the administrator can extend the survey template to further qualify the questions into such categories as the level of difficulty and the category of questions (theme, character, etc.). To illustrate this concept, the following table outlines a sample template:

| #Question | Type of Question | Subject | Level Difficulty |
|---|---|---|---|
| 1 | Advertisement | General | Easy |
| 1 | Advertisement | Theme | Difficult |
| 2 | Show | General | Moderately Difficult |
| 1 | Show | Character | Difficult |
| 1 | Show | Location | Easy |

In the preferred embodiment, at the time a member takes a survey, the survey formula is resolved and the show and ad questions are randomly selected, randomly ordered and placed onto a stack. The questions are taken off the top of this stack one at a time and presented to the Member. When a question, based on the Member's response invokes a follow-up question, then that question or questions are placed the stack. The survey is complete once the stack has been emptied. Refer to section on ‘Consumer Survey Interface’ for a more complete process and design functionality surrounding surveys.

Integration of Survey and Questions Technical Overview

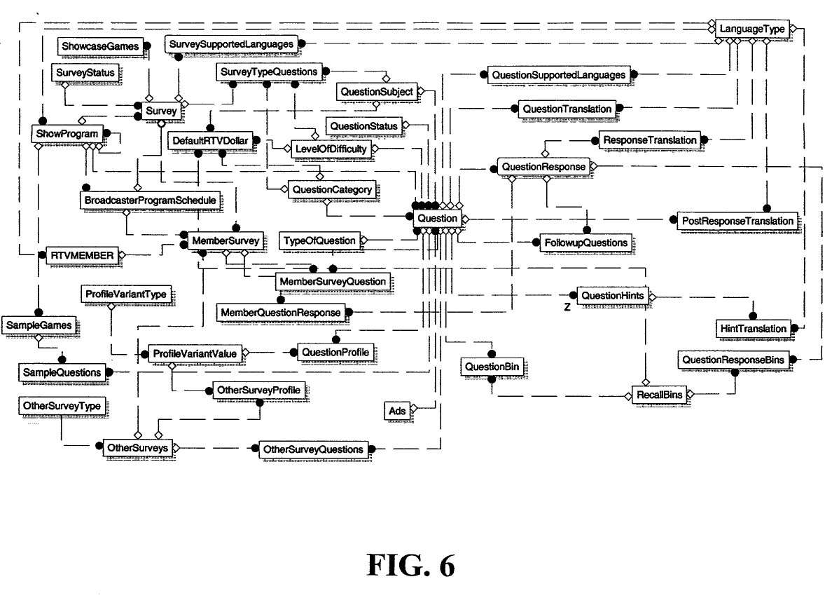

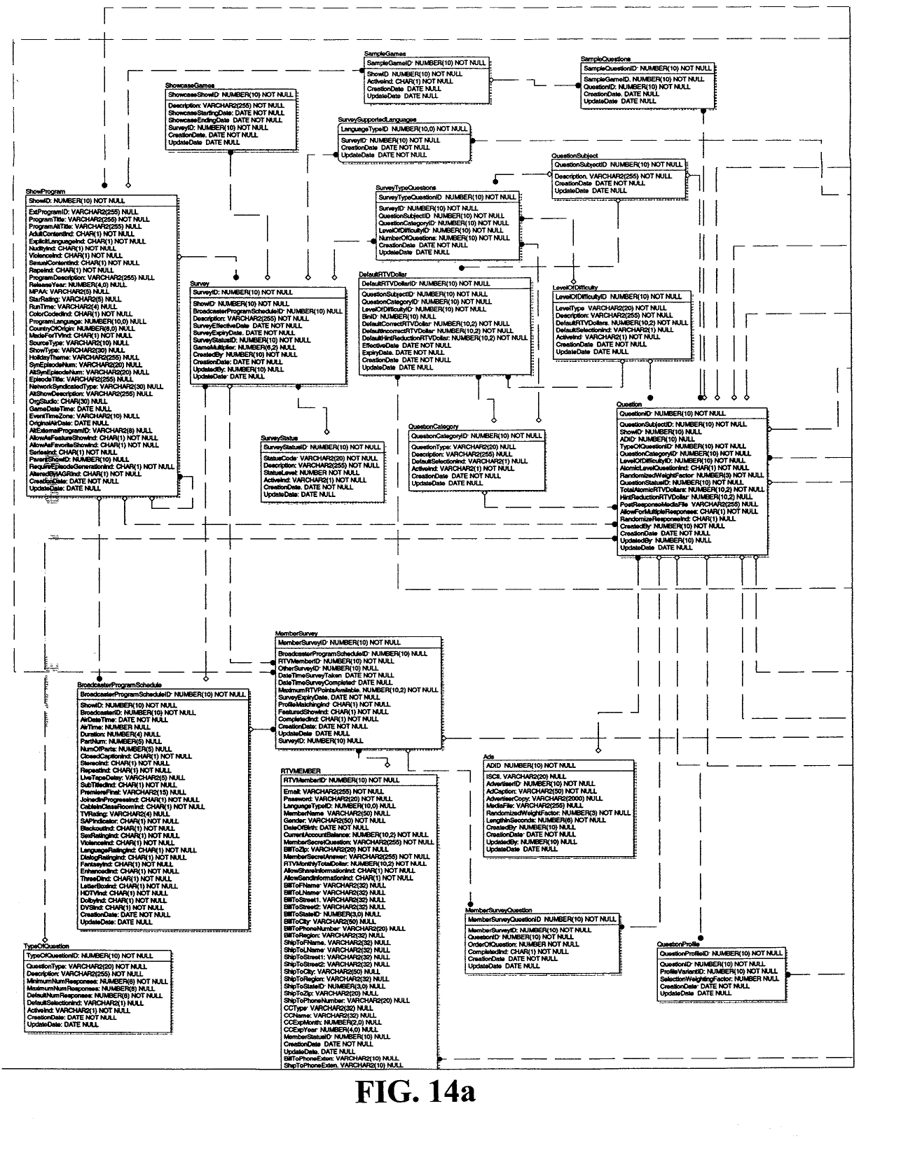

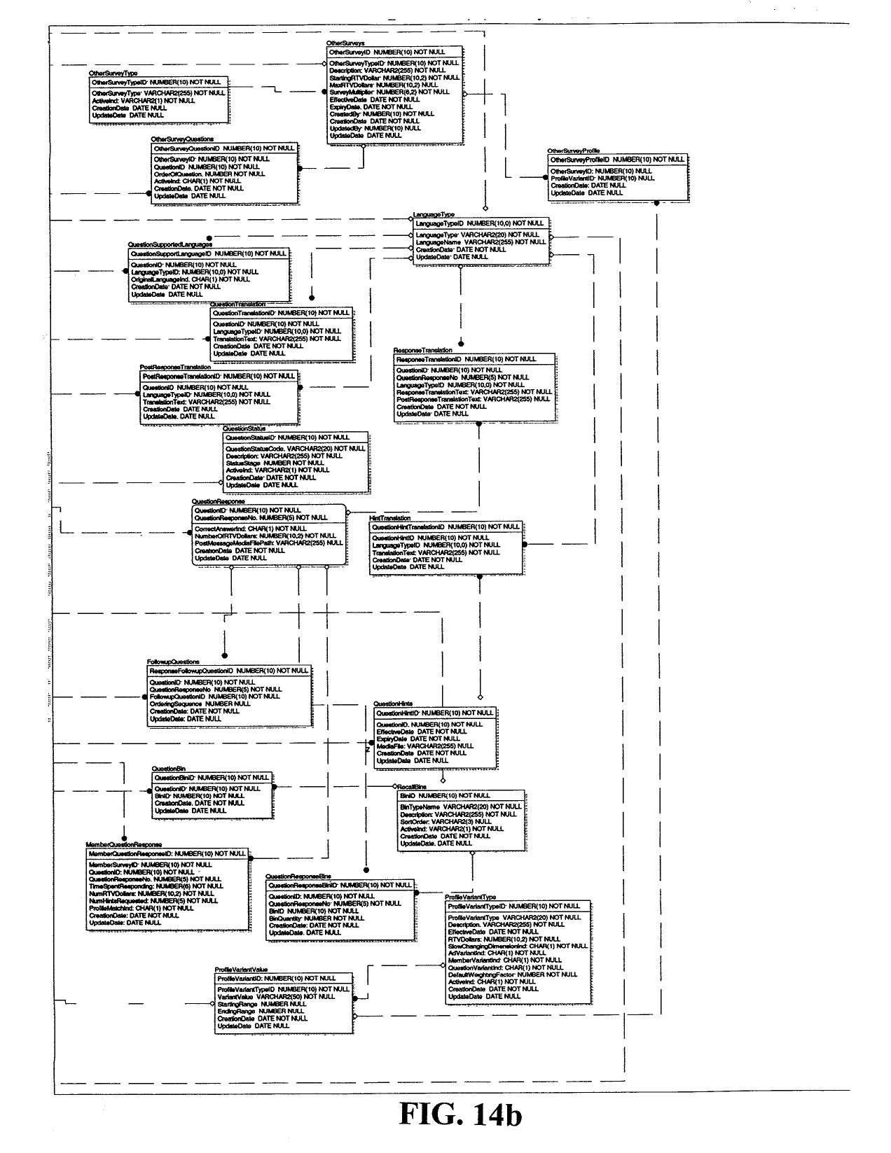

FIG. 6 is an entity relationship diagram showing an example of the survey and questions subtopic data model in accordance with a preferred embodiment. In the figure, the ShowProgram and BroadcasterProgramSchedule entities comprise a subset of the TV Listings and Flighting Schedules tables; the Ads entities are the domain structure tables; the SurveyStatus, DefaultRTVDollar, QuestionSubject, QuestionStatus, LevelOfDifficulty, QuestionsCategory, TypeOfQuestion, ProfileVariantType, ProfileVariantValue, OtherSurveyType, LanguageType, and RecallBins entities comprise a subset of code tables; the RTVMember entity comprises a subset of members' tables; the ShowcaseGames, Survey, SurveySupportedLanguages, SurveyTypeQuestions, SampleGames, SampleQuestions, OtherSurveys, OtherSurveyProfile, and OtherSurveyQuestions entities comprise Surveys tables; the QuestionSupportedLanguages, QuestionTranslation, ResponseTranslation, QuestionResponse, PostResponseTranslation, Question, FollowupQuestion, QuestionHints, HintTranslation, QuestionProfile, QuestionBin and QuestionResponseBins entities comprise the Questions tables; and, the MemberSurvey, MemberSurveyQuestion, and MemberQuestionResponse entities comprise a subset of the Member's responses. Refer to FIGS. 14a and 14b, which show an entity relationship diagram illustrating the details of the data model for the Question and Survey Subject Area.

Members Technical Overview

Member information may include, e.g., signup demographic information, additional profiling information, favorite shows and ranking, redemption and survey results. The member's actual survey responses and the amount of proprietary currency associated with that question's response will be maintained. The actual bin and thus value added to the bin is preferably maintained within the survey and question section.

In order to maintain a member's account balance, a line item is preferably created for each transaction that has occurred against the member's proprietary currency account. These transactions, wherever possible, will maintain a link to the full details of the transaction. For example, survey line items will maintain a reference to a specific membersurvey record and thus the full detail transaction record. Redemption line items will maintain a reference record of the items that a member has redeemed.

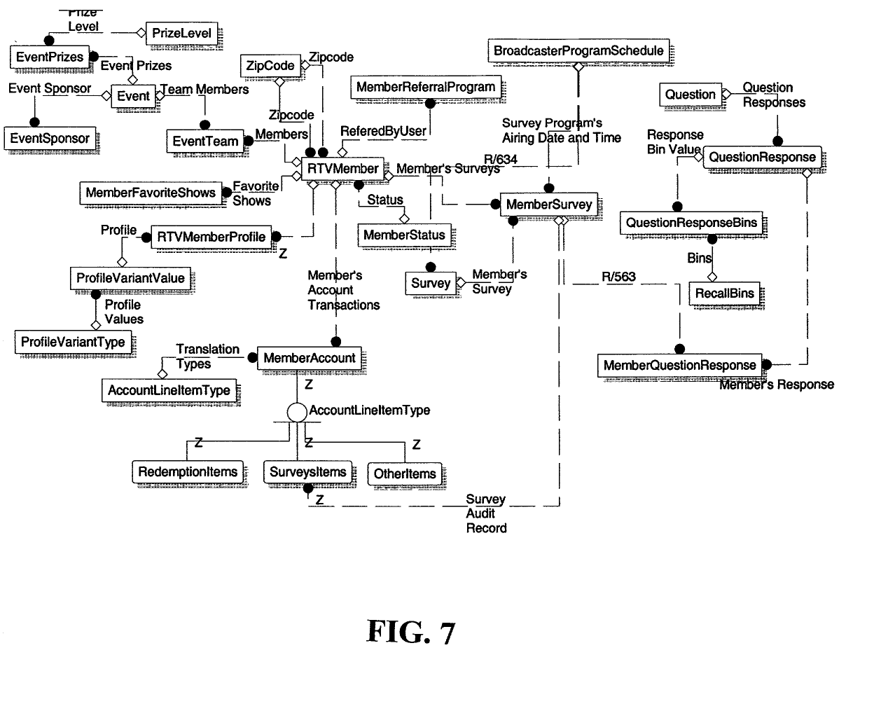

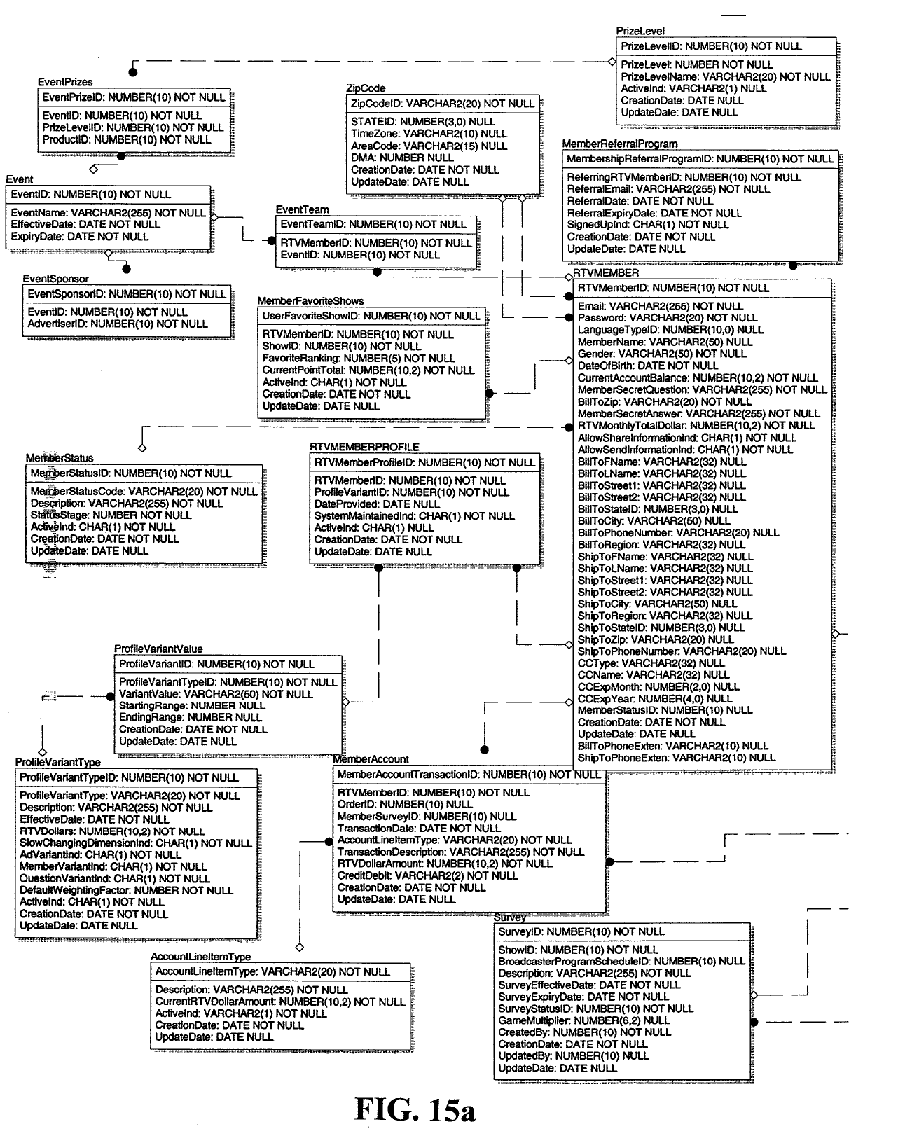

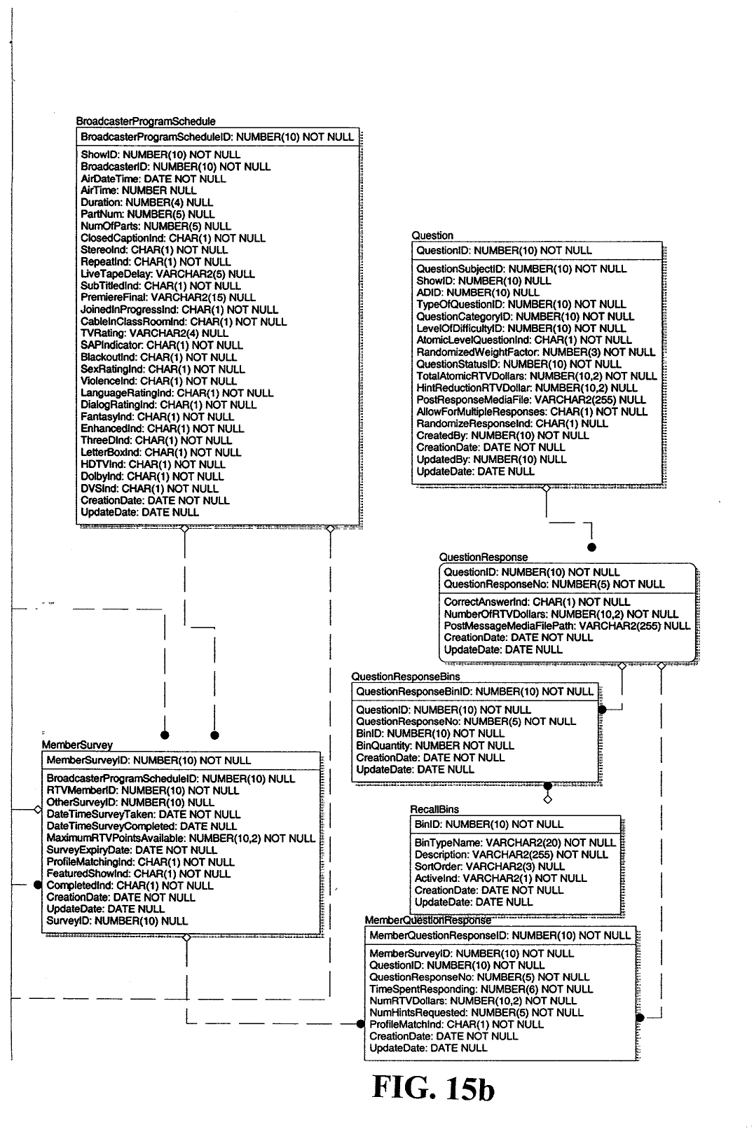

FIG. 7 shows an example of the architecture of the members' subtopic data model. In the figure, The PrizeLevel, ZipCode, MemberStatus, ProfileVarianValue, ProfileVariantType, AccountLine ItemType, RecallBins entities comprise a subset of code tables; the Survey entity comprises a subset of Surveys tables; the Question, QuestionResponse, and QuestionResponseBins entities comprise a subset of Questions tables; the EventPrizes, Event, EventSponsor, EventTeam, MemberReferralProgram, RTVMember, MemberFavoriteShows, RTVMemberProfile, MemberAccount, Redemptions, SurveysItems, and OtherItems entities comprise member's tables; the BroadcastProgramSchedule entity comprises a subset of the TV listings and Flighting Schedules tables; and, the MemberSurvey and MemberQuestionResponse entities comprise a subset of the Member's responses. Refer to FIGS. 15a and 15b, which show an entity relationship diagram illustrating the details of the data model for the Member Subject Area.

Community Events Technical Overview

To increase the overall effectiveness of the consumer proposition, a virtual community of members can be teamed together in order to compete against other teams of members in a community event. During the event's effective time period, proprietary currency that each member accumulates will be counted towards the team's aggregated score. At the completion of the event, the teams' aggregated scores determine the order they finished. The winners of the prizes are based on the team's aggregate score. For example, the 1^{st} place prize(s) may be awarded to the team with the highest score, and 2^{nd} place prize(s) may be awarded to the team with the next highest score. In the event of a tie, the team's scoring history may be used to determine which prize package a team will win.

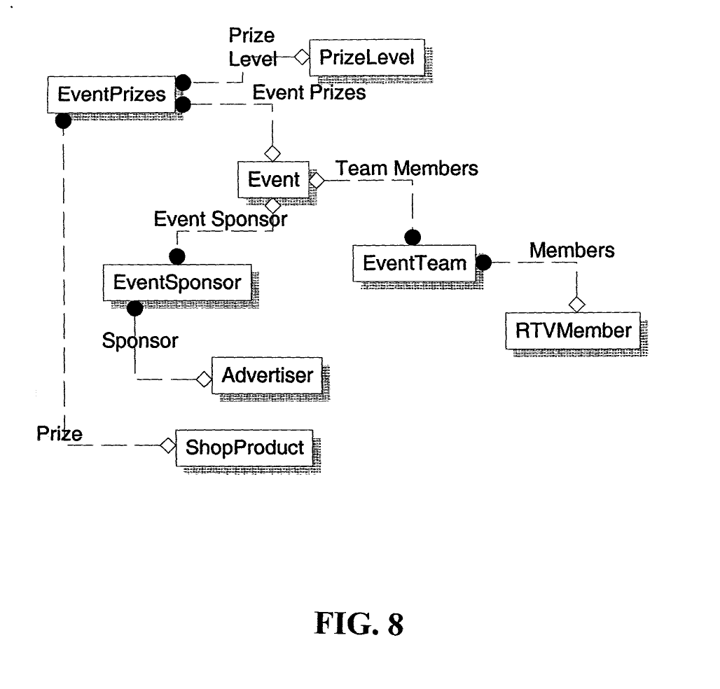

FIG. 8 shows an entity relationship diagram illustrating a subtopic data model for community events. In the figure, the PrizeLevel entities comprise a subset of code tables; the EventPrizes, Event, EventSponsor, EventTeam, and RTVMember entities comprise member community tables; the Advertiser entity comprises a domain structure table; and, the ShopProduct entity comprises a rewards catalogue table. Refer to FIGS. 15a and 15b, which show an entity relationship diagram illustrating the details of the data model for the Member Subject Area.

Rewards Technical Overview

Rewards include, e.g., items available to members through a member catalogue and/or rewards that are part of the overall value proposition to members but are not directly offered as items within the members' rewards catalogue (for example, double, triple proprietary currency, and special sweepstakes items). The entire rewards engine is preferably designed to support an unlimited number of languages. The rewards engine is preferably designed around a self-administration model allowing for the rewards administrator to maintain not just the list of products, but also variances to the products. The variances for one product can be different from variances for another product. For example, a variance for clothing might include size and color.

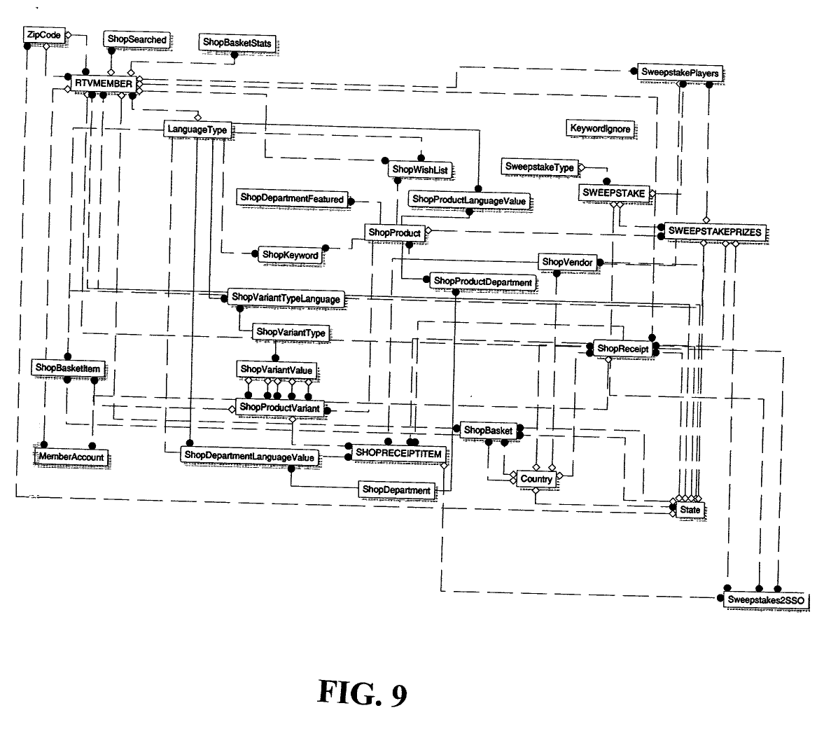

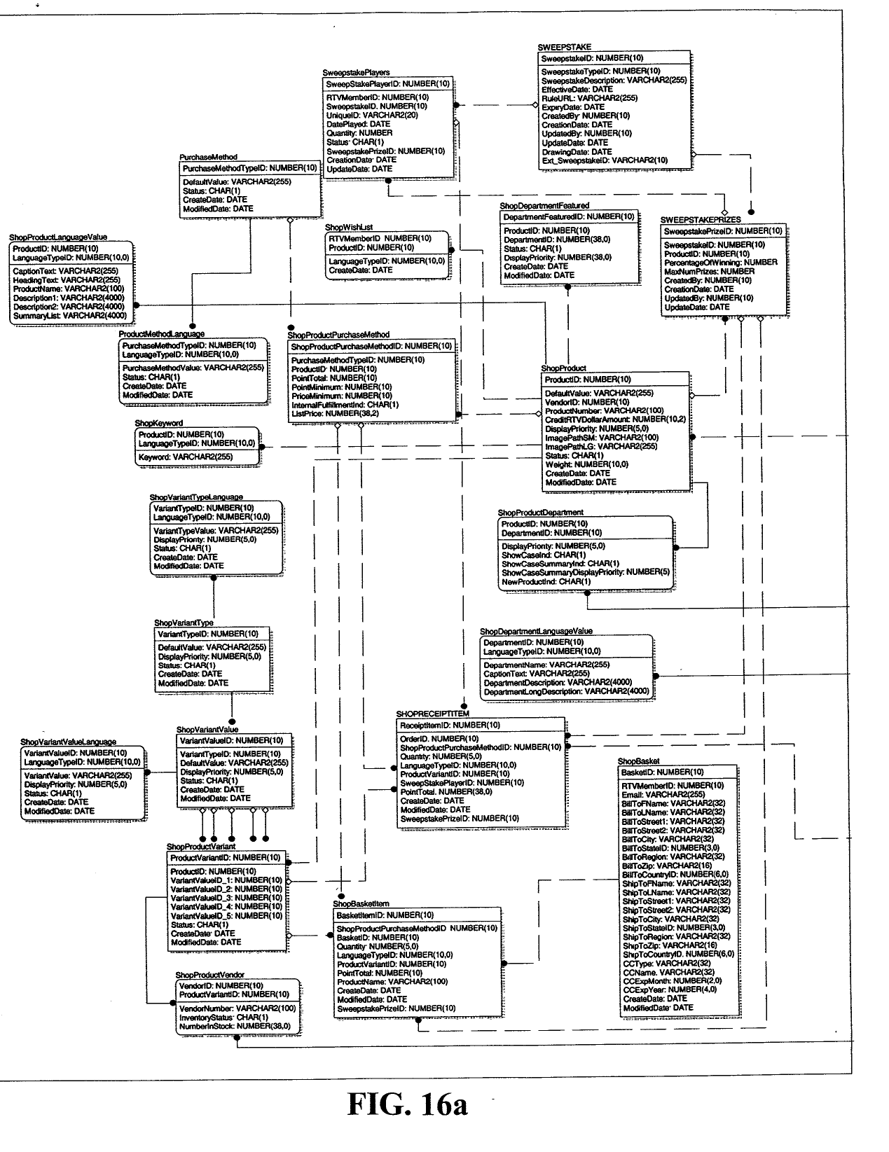

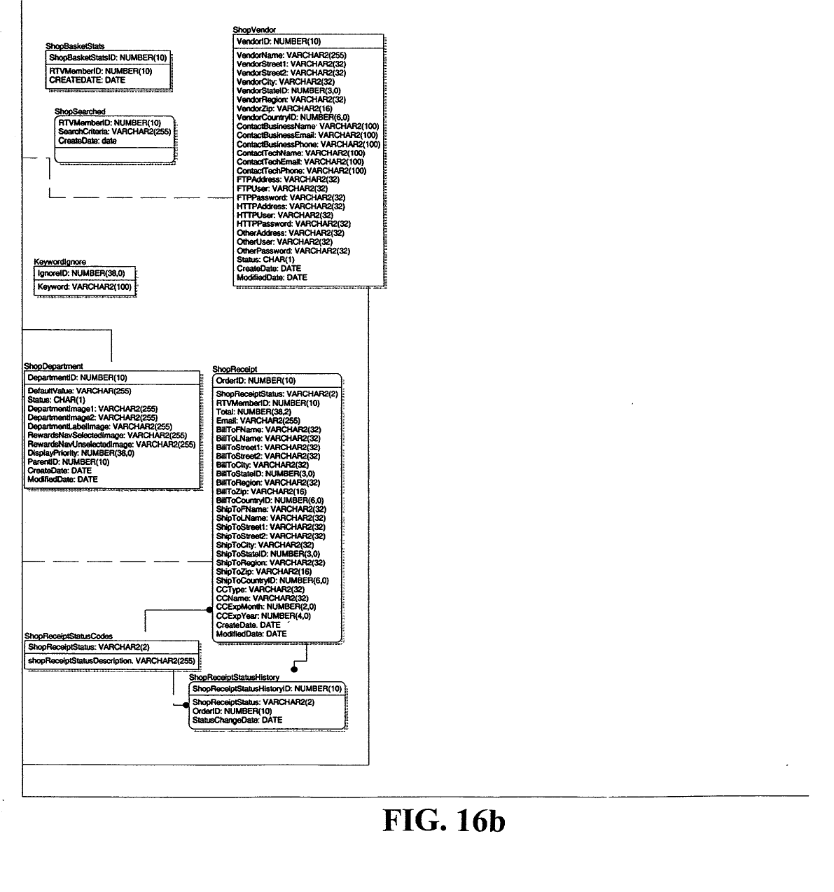

FIG. 9 is an entity relationship diagram showing an example of a rewards subtopic data model in accordance with a preferred embodiment of the invention. In the figure, the ZipCode, LanguageType, SweepstakeType, Country, and State entities comprise a subset of code tables; the RTVMember and MemberAccount entities comprise member community tables; and, the ShopSearched, ShopBasket Stats, SweepstakePlayers, KeywordIgnore, Sweepstake, SweepstakePrizes, ShopWinList, ShopDepartmentFeatured, ShopProductLanguageValue, ShopProduct, ShopKeyword, ShopVendor, ShopProductDepartment, ShopReceipt, ShopVariantTypeLanguage, ShopVariantType, ShopVariantValue, ShopProductVariant, ShopBasketItem, ShopDepartmentLanugageValue, ShopDepartment, ShopBasket, ShopReceiptItem, and Sweepstakes2SSO entities comprise rewards catalogue tables. Refer to FIGS. 16a and 16b, which show an entity relationship diagram illustrating the details of the data model for the Rewards Catalog Subject Area.

Consumer Site Technical Summary

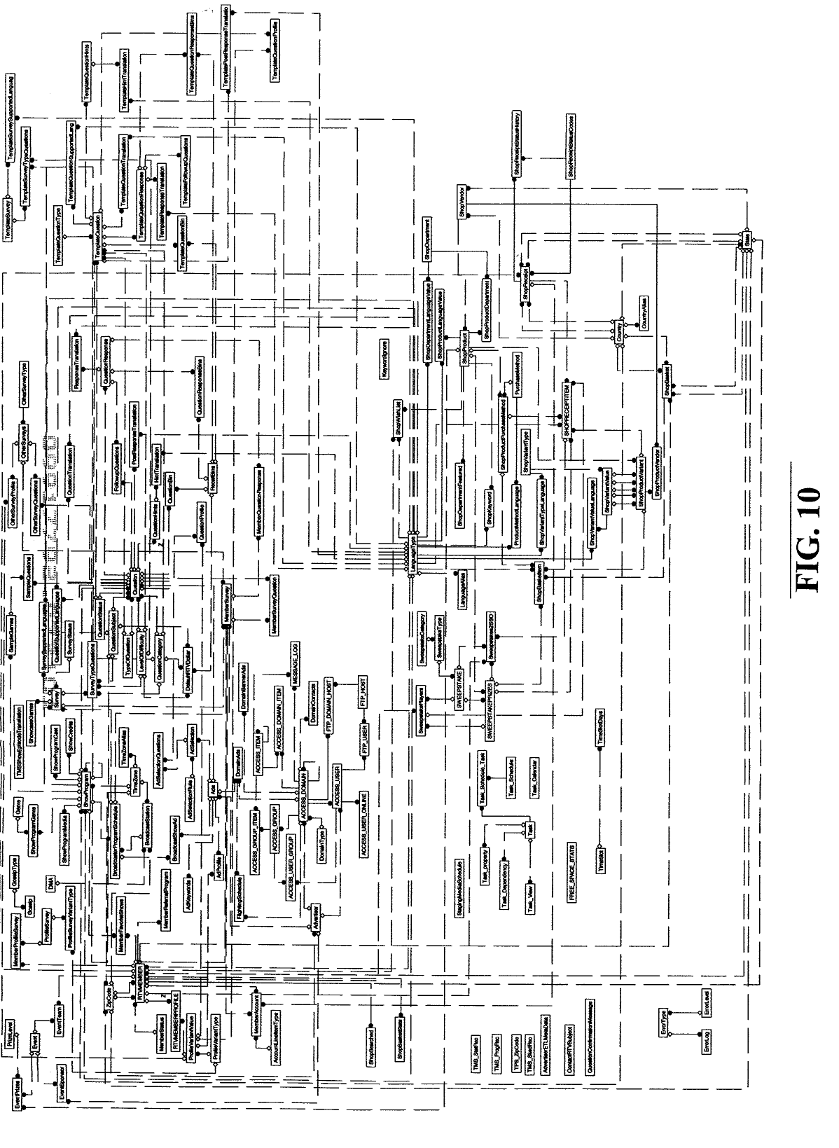

FIG. 10 is an entity relationship diagram illustrating the consumer site's preferred overall entity relationship model. This model depicts the interrelationship between the various sections to produce the entire solutions.

Site Management Maintenance

Survey Management Application

The purpose of this application is to allow non-technical users to administer the tests (e.g., a series of questions presented to a user) that are displayed on the web site. The application is to be used by the administrators of the system. A non-technical administrator inserts the questions, possible answers, answer type, hint, ads, and point totals. Advertisers may be given the ability to associate questions with advertising campaigns and product brands. Multiple questions are grouped into a single test. Before a test is displayed on the production web site an administrator must approve it.

Operation of the survey management application is preferably as follows. The Administrator selects the language desired and types in the question in a HTML text box. The Administrator also selects the question type, e.g., checkbox, radio, single-pull down, or multiple-pull down. The administrator may insert the desired number of answers. If a question has a correct answer then hints may be inserted. A hint will be displayed to the member in efforts to trigger the correct response. The administrator selects or enters the number of points awarded to the user for answering the question incorrectly and correctly. He may also be permitted to select a banner ad to display when a user answers a question incorrectly. The survey management application preferably permits the administrator to select the question type, i.e., whether the question is a content question or an ad question.

Administration Module

Some of the business functionality preferably designed into the survey creation toolset is as follows:

Each option has multiple parallel conditional branching. That is, by choosing an option, the consumer will be asked several subsequent question(s).

A question cannot be published if there are missing translations for the question, responses, or hints.

The toolset allows the member to resume a still-valid survey and keeps a record of what question a member is at within a survey. This allows the system, given an incomplete survey, to start where the user left off, and can be used to limit members from skewing the survey information by navigating back to previous questions.

Allows, for example, the following types of questions:

Yes/No

True/False

Multiple Choice

Choose all that apply

Scaling

Allows for a post message to be defined with each option.

Provides for the ability to associate media (pictures, sound, video . . . ) to a question.

Captures the author of the survey and who last updated the survey.

Captures the author of the individual questions and who last updated the question.

Creates details about a question

Description of a question (over multiple languages)

Associates media (pictures, sound, video . . . ) with each question. Allows for the media to be placed (before, after, embedded within a question,) sizing of media

Allows for all question text, options, and hints to have embedded HTML tags. This allows for flexibility in presenting text to the Member.

Provides a running total of points above each question

Provides the question number and the number of remaining questions above each question.

Each choice has a number of points associated with it.

Each choice has potential follow-up questions associated with it.

All surveys support multiple languages.

Game Delivery to Members

A software application, referred to herein as “Play RewardTV,” is provided to deliver games to members and allows members to earn points by answering questions, for example, about a television show and the advertisements that occurred during the program. A member may only take a test once. The results are stored in the database and the analysis of the results is conducted within the trendreporter (data warehouse).

ADs Selection Algorithm

The following examples of Ad selection methods are useful for gauging the effectiveness of client ads:

a) Ad Showcase Rules—Over a given time frame, administrators can directly focus a set of ads for which they want to gauge the members' responses. The system can focus directly on specific questions that will be asked to members once the ad has been selected.

b) Profile Matching—To effectively manage this selection process, members and ads have profiles associated with them. These include, for example, “Sex”, “Age”, “Marital Status”, and “Income Level”. The system cross-references the member's profile and the ad's profile (that aired during the program) to determine the Ads that best match the member's profile. To further provide effective selection criteria, each profile type assigned to an ad is assigned a level of importance (“SelectionWeightingFactor”) attribute. For example, matching on gender may have more importance than matching on income level. Advertisers profile (target) their ads to a certain demographic makeup. The system uses ‘Profile Matching’ to best match the member's profile to ads that are directed towards their profile.

The profile cross-referencing arranges ads by this weighing factor and selects the top predetermined number of Ads having the highest scoring factor.

The above rules can be integrated to effectively perform a more sophisticated and targeted program directed at members.

The flighting schedule ads are preferably compared against the profile-matching algorithm to produce a profile-matching score. If there is an ad showcase rule that covers today's date then that rule is applied against the flighting schedule ads to produce a showcase matching score. The ad showcase matching and profile matching scorings are aggregated together. The actual number of ads selected is based on the survey template.

Question Selection Algorithm

As with members and ads, a question preferably has optional profiling associated with it. As with ads, the profiling of a question involves selecting the appropriate profile types and indicating the level of importance (“SelectionWeightingFactor”). The profile cross-referencing arranges the list of questions by this weighing factor and selects the top predetermined number of questions having the highest scoring factor. This algorithm is applied against the program to determine the actual program related questions that will be asked. A similar algorithm is applied against each of the selected ads (Section 4.5.4.1) to determine which ads' questions will be asked. The actual number of program and ad questions is based on the survey template.

Background Processing Steps

Step 1—Selection of Survey. An “information system” component of the system and method of the invention captures the show, date and time of airing, and the network broadcaster from the Member. This is accomplished once the member selects a particular show. This information is provided as a parameter in the form of the ‘BroadcasterProgramSchedule’ primary key. Using this record, the information system determines the ‘ShowProgram’ record and the program's active survey stored within the ‘Survey’ take.

Step 2—Identify types of questions—Using the ‘Survey’ record identified within Step 1 to determine the make-up of the survey, the system uses the ‘Survey’ and ‘SurveyItems’ information to determine the number and breakdown of questions. For example, it determines the number of show content questions and the number of ad content questions. In addition, the ‘SurveyItems’ table further details the level of difficulty (Easy, Difficult . . . ) and Category (Theme, Character, Setting . . . ) that further restricts the list of potential questions that might be asked to the Member. For example, the survey can have the following survey items:

Two Ad related questions. One question on “Theme” category that has a level of difficulty of “Moderate”. One question on a “Settings” category having a level of difficulty of “Difficult”.

Four Show related questions. Two questions on a “Theme” category that has a level of difficulty of “Moderate”. One on “Settings” category having a level of difficulty of “Difficult”. One on “Character” category having a level of difficulty of “Difficult”.

Step 3—Identify Flighting Schedule of Ads—Using the Show, time, location and network determined within Step 1, the system determines the actual flighting (ads) that aired during the program. This can be accomplished by joining the ‘BroadcasterProgramSchedule’ with the ‘BroadcastShowAds’ table.

Step 4—Selection of Ads—Using the ‘Ad Selection Algorithm’ listed above along with the results of Step 2 and 3 the system selects the actual atomic questions that will be asked to the member. These are recorded within the table “MemberSurveyQuestions”.

Step 5—Selection of Questions—Using the ‘Question Selection Algorithm’ listed above with the results of Step 2, the system selects the actual atomic questions that will be asked to the Member. These are recorded within the table “MemberSurveyQuestions”.

Step 6—Ordering of Questions—The resulting questions from Steps 4 and 5 are randomly ordered and presented to the member. This includes questions relating to programs and ads. As orders of questions are identified they are placed on a stack. The stack serves as the mechanism from which to pull the next unanswered question and present to the member. Follow-up questions are placed on the top of the stack. The survey is completed once the stack has been emptied.

Foreground Processing Steps

Step 7—Determine the Bonus Dollars for taking the Survey—Members are awarded a base level of proprietary currency for taking part in a survey. The database determines what this amount is and displays this amount to the member.

Step 8—Determine Worth of Surveys—The system may traverse the selected list of questions and all the potential list of questions and determine the maximum number of points available for these questions during this survey. This number is recorded within the MemberSurvey table. The Question table includes an attribute ‘TotaLAtomicRTVDollars’. This field includes the potential proprietary currency for this question and all subsequent follow-up questions to this question structure. This amount is presented to the Member within the Survey scoreboard.

Step 9—Present Question to Member—The system takes the top question from the stack and presents the question and the list of responses to the Member. The maximum value of the question (not taking into account any follow-up questions) is the response having the maximum proprietary currency amount. The database (QuestionConfirmationMessage) is accessed to determine whether the member correctly or incorrectly answered the question, and an appropriate confirmation message is displayed.

Step 10—Present Hint—When the member has incorrectly answered the question, the system checks to see if there are any hints associated with the question. If there is an associated hint, that Hint (text and media file) is displayed, the response is blanked out, the value of the question is reduced and the Member is permitted to re-answer the question.

Hints are stored within one or more “QuestionHints” table(s). The reduction amount is within the “Question” table. A question can have zero or more hints associated with it. If the Hint has a reduction in point value, then the current point total for that question is updated. The hint media file is stored within the ‘QuestionHints’ table. The text is associated within the ‘HintTranslation’ table. The system records that the member's response was based on being provided a hint.

Step 11—Display Post Message—Any “post message” is played once the member has answered the question and they are proceeding to the next question (any hints have already been played). Each question may have an overall “post response” that, once defined, will be played over all responses with one exception. Each question response may have its own post response message and/or media file. If this is the case, when the member selects that response as the answer, then that message will be played instead of the default overall post response.

Step 12—Process Follow-up Question(s)—The system checks, based on the user's selected response, whether there are any follow-up questions. It places all of the responses' follow-up questions, which do not appear on the stack (i.e. has already been asked or still to be asked), on top of the stack. A response may have zero or more follow-up questions associated with it.

Step 13—Update Survey Scoreboard—Based on the member's selected response, the system recalculates and updates the survey's scoreboard. This scoreboard details the number of points the member has received for this survey.

Step 14—Next Question—Repeat Step 9 through 13 until the Member has answered all required questions.

Step 15—Calculate the total number of points the Member has received for this survey. Once the survey has been completed, the member's account balance is updated. In addition, the transaction is recorded within the ‘MemberAccount’ table.

Client Site Technical Overview

The overall client site is preferably broken down into several services: Client Product Structure; Client TrendReporter, and Multidimensional Analysis. These are discussed below.

Client Product Domain

The Client product domain structure allows the client to self-define their product structure. Each client has a separate domain structure and only one client and the client's designated users have access to that structure. This critical relationship is maintained at the database level to ensure that clients do not have access to other client's domain structure.

In essence, a client can define and maintain their product structure. The domain structure is made up of levels and each level has one or more domain level items. The following outlines an example of a potential client domain classification structure: At Level 0 is a client; at level 1 are several of the client's brands; at level 2 are specific products within each brand. There are no limits to the number of levels within a domain. Accesses to domain items are granted to groups. Users are assigned to one or more groups. A user having access to multiple domain items is given the highest level of that arm of the domain. Access to a domain item automatically gives access to all items (levels) below that domain item. Groups are assigned the security rights to maintain their assigned sub-domain. These rights allow clients to create, update and delete users and assign them to groups within their sub-domain.

A client's ads can belong to any level of the client's product domain structure. As an example, ads can be associated with specific products while other ads can be defined at other levels of the domain structure. Ads that are not associated with a specific product can cover all levels below that sub-domain structure. For example, a car manufacturer can have an ad covering all cars and not to a specific car.

In addition, the system is preferably designed to be flexible enough to accommodate various classifications of ads. Ads can be placed within other domain structures to provide for a different classification of an ad. For example, the data gathered around the ad's effectiveness may not be classified only according to the Client's product structure, but can also be reclassified into other product structures (e.g., Nielsen's, CMR). This reclassification is done independent from how the effectiveness is gathered on the ad.

This client product domain structure allows clients great flexibility in analyzing their ads effectively. The other key components include TV listings, Surveys and questions, and Member's profiles. An Ad's effective can, as an example, be analyzed by Ads at the domain level, or the effectiveness can be the result of aggregating the effectiveness of all Ads below a domain item.

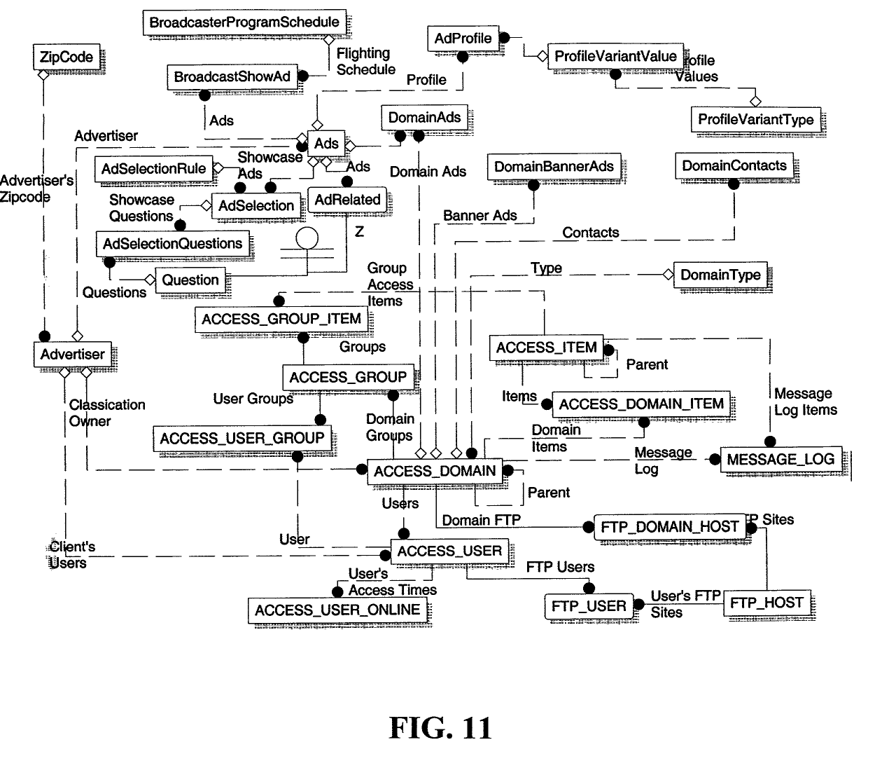

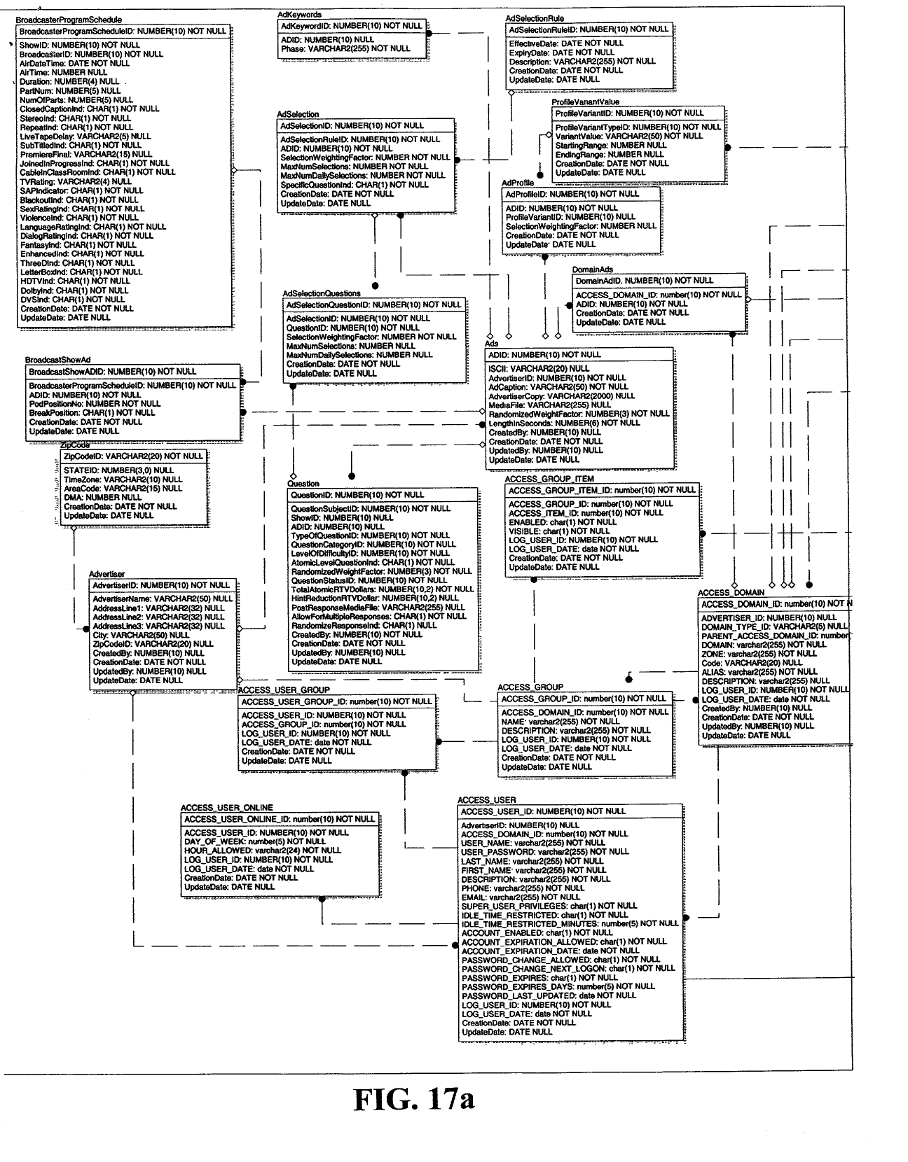

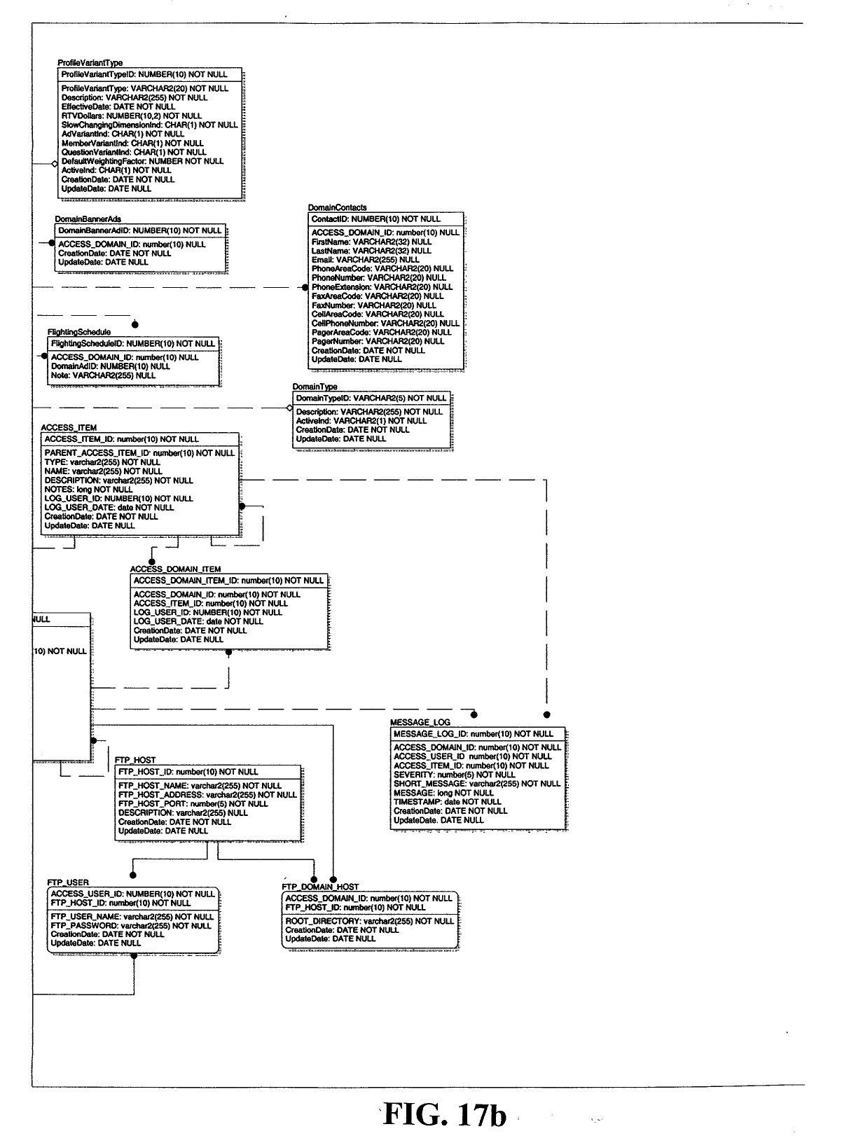

FIG. 11 shows an entity relationship diagram illustrating a client product domain structure data model in accordance with a preferred embodiment of the invention. In the figure, the BroadcasterProgramSchedule and BroadcastShowAd entities comprise a subset of the TV listings and Flighting Schedules tables; the AdRelated and Question entities comprise a subset of the Questions tables; the AdProfile, DomainAds, DomainContacts, Ads, AdSelection, Rule, AdSelection, AdSelectionQuestions, and Advertiser entities comprise domain structure tables; and, the ZipCode, ProfileVariantValue, ProfileVariantType, Domain, and Type entities comprise a subset of code table. Refer to FIGS. 17a and 17b, which show an entity relationship diagram illustrating the details of the data model of the Advertiser Domain Subject Area.

The domain structure is a flexible reporting and analysis subsystem allowing clients the flexibility to self-administrate their product hierarchy. At the lowest level (database entities and rules), a client's ad cannot be placed within another advertiser's domain. In addition, users are assigned to a client and are only (implemented at the database level) allowed to be part of that client's domain structure. That is, the database will not allow the user to see any other client's domain.

The structure allows for a secure reporting environment that allows selective access to a client's product hierarchy. For example, the administrator can grant access to a user at any level of the domain structure. In addition, a user can be granted access at various levels of the domain structure. A client's advertising agency, for example, can be granted access to only the level(s) of the domain structure for which it is responsible. They are not aware of any other domain structure within the organization. This provides the client with the ability to provide its advertising agency with real-time reporting and analysis of the campaigns they run. This flexible reporting structure also allows for activities for which that user can perform. For example, an administrative group can be established at any level of the domain structure allowing for self-administration of that sub-domain. This, in essence, allows for delegation of administrative power reducing the burden and bottleneck of administration of product structure.

Client TrendReporter

In accordance with a preferred embodiment of the invention, the reporting structure includes a trend reporting component, referred to herein as the client trendreporter. It is through the reporting structure that clients analyze their ad's effectiveness. Data from the consumer site is Extracted, Transformed, and Loaded (ETL) into a structure suited for reporting against. The reasoning for this ETL is threefold. First, ETL is performed in order to reduce the workload of consumers affecting the advertiser's reporting. Second, the means of gathering information is vastly different from the means of reporting information. Third, ETL is performed to provide a level of physical abstraction of the consumer data from client data.

Client Data Model—Star Schema

The client data model is preferably organized into a “star schema,” allowing for a more efficient reporting structure. The schema is broken down into one “fact” and multiple “dimensional” tables. The fact table is an aggregator of the dimensions or more precisely, ‘measures’ the dimensions. Thus, the fact table includes, for example, the BinQuantity, NumberOfHints, and TimeSpentResponding.

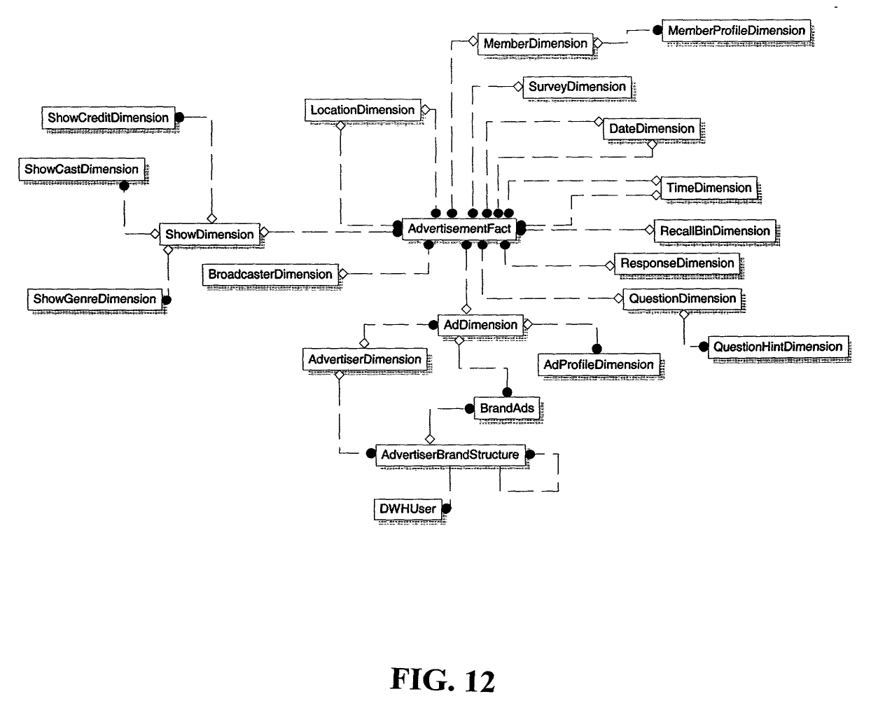

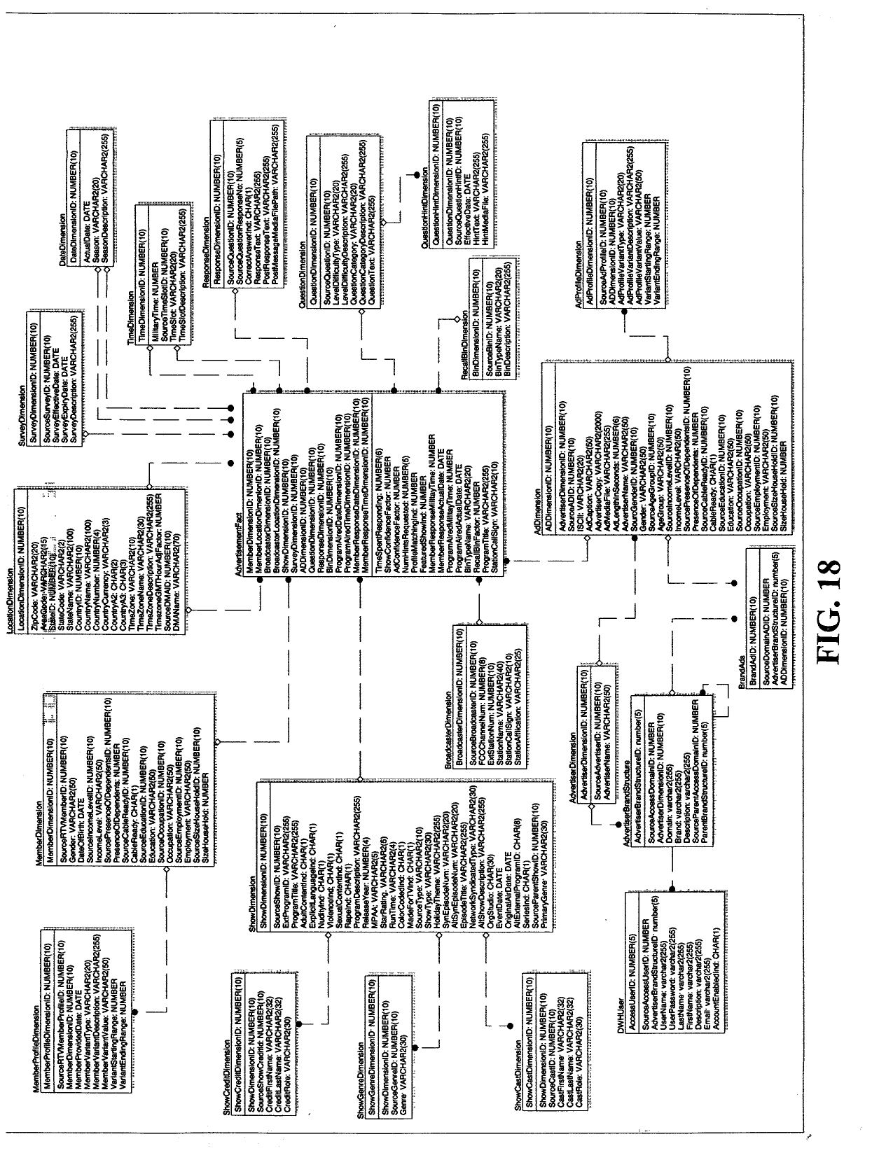

This data model allows the system to provide answers to many types of question(s), such as what age demographic provided what sort of response to which particular ad. FIG. 12 shows an entity relationship diagram illustrating the client domain subject area. As shown, the dimensions can be combined, in any order, to produce different aggregations (measures) of effectiveness. In the figure, the ShowCreditDimension, ShowCastDimension, ShowDimension, ShowGenreDimension, and BroadcasterDimension entities comprise a subset of the TV listings and Flighting Schedules tables; the ResponseDimension, QuestionDimension, and QuestionHintDimension entities comprise a subset of the Questions tables; the AdDimension, AdvertiserDimension, and AdProfileDimension entities comprise domain structure tables; and, the LocationDimension, DateDimension, TimeDimension, and RecalBinDimension entities comprise a subset of code table. Refer to FIG. 18, which shows an entity relationship diagram illustrating the details of the data model of the Client Data Warehouse Subject Area.

Client Domain Structure Application

This subsystem allows RTV or Client administrators the tools for maintenance of the clients domain structure. From a security point-of-view, only one client can own the ads within a domain structure. This level of security is enforced at the data model level. As such, only users that are assigned to that client can be assigned to that client's domain structure. Different Users can be assigned different levels of access. The domain structure also includes the structure of the ads. The Client domain subsystem is designed to truly allow for self-administration. An administrator can provide administrative rights to users at or below the administrators own domain level. In addition, other security rights are maintained within the domain subsystem. The above functionality is included within a user-friendly interface.

Extraction, Transformation, and Load (ETL) Process

An ETL process is used for populating and maintaining the information within the data warehouse. This process extracts the data from the source system (consumer site), transforms it to accommodate reporting requirements, and loads it to the reporting structure (Star Schema).

Star Schema's Dimensional Integrity ETL Process

This process is defined to maintain the integrity between the consumer site and client data warehouse systems. An additional meta data table ‘AdvertiserETLMetaData’ is added to consumer site tables. This table includes the list tables that are used to maintain the data warehouse's data. Each row includes the table name along with the last date and time that table was successfully extracted, transformed and loaded into the data warehouse.

The following consumer site tables can be configured to maintain the System Integrity ETL process:

| | Advertiser TrendReporter Target |
|---|---|
| Consumer Site Source Table | Table(s) |
| Zip Code, State, Country, Time Zone | LocationDimension |
| BroadcasterProgramSchedule, | Date and Time Dimensions |
| MemberQuestionResponse | |
| RTVMember | MemberDimension |
| AdditionalMemberProfile, | MemberProfileDimension |
| ProfileVariantValue, | |
| ProfileVariantType | |
| BroadcasterStation | BroadcasterDimension |
| ShowProgram | ShowDimension |
| ShowProgramCast | ShowCastDimension |
| ShowCredits | ShowCreditDimension |
| ShowProgramGenre, Genre | ShowGenreDimension |
| Advertiser | AdvertiserDimension |
| Ads | AdDimension |
| AdProfile, ProfileVariantValue, | AdProfileDimension |
| ProfileVariantType | |
| Survey | SurveyDimension |
| Question, QuestionTranslation, | QuestionDimension |
| LevelOfDifficulty, QuestionCategory | |
| QuestionHints, HintTranslation | QuestionHintDimension |
| QuestionResponse, | ResponseDimension |
| ResponseTranslation | |
| RecallBins | BinsDimension |

Advertiser TrendReporter

The TrendReporter is used to give advertisers insights into the effectiveness of their advertising campaigns. The TrendReporter displays schedule reports, and may also be used to report on the following:

Nielsen A18-49 Rtg—% of Total A18-49 universe who watched a given program

RewardTV A18-49 Rtg—% of RTVA18-49 universe who watched any portion of a given program—and correctly answered the episode questions

RewardTV vs. NTI Index—The relationship between the RewardTV rating and the NTI rating expressed as an index where 100 is average

Avg. Ad Recall—Average % of viewers who accurately recall any ads in the average episode of this show

Brand Recall—% of viewers of this episode of this show who accurately recall a specific brand's ad

Recall Index—The relationship between the Ad Recall and the Brand Recall expressed as an index where 100 is average

RewardTV Recall Rtg—The RewardTV rating multiplied by the Recall Index to recalculate the ratings to incorporate the shows ability to provide improved recall for this advertiser

Top 2 box liking—% of viewers who recalled the brand's ad and rated it as an ad that they “liked a lot” or “liked somewhat”

% favorites—% of total user universe who list this program as one of their three favorite programs

QUAL Score—Combined brand recall, top 2 box liking and % favorite score. This can be weight averaged to reflect varied importance of each factor

QUAL Index—The relationship of each show's QUAL Score to the average QUAL Score for the campaign expressed as an Index where 100 is average

In order for the advertisers to understand the reach and effectiveness of the system, statistics about the number of users can be displayed. The following are the scheduled reports that may be run for this section.

RTV_Universe-Report_{—}1—Separates users into age groups and displays the number of users, the percent composition, and the percent coverage for last night.

RTV_Universe-Report_{—}2—Separates users into age groups and displays the number of users, the percent composition, and the percent coverage for last week

RTV_Universe-Report_{—}3—Separates users into age groups and displays the number of users, the percent composition, and the percent coverage for last month.

RTV_Universe-Report_{—}4—Separates users into age groups and displays the number of users, the percent composition, and the percent coverage for year to date.

RTV_Universe-Report_{—}5—Separates users by gender and displays the number of users, the percent composition, and the percent coverage for last night.

RTV_Universe-Report_{—}6—Separates users by gender and displays the number of users, the percent composition, and the percent coverage for last week

RTV_Universe-Report_{—}7—Separates Users by gender and displays the number of users, the percent composition, and the percent coverage for last month.

RTV_Universe-Report_{—}8—Separates users by gender and displays the number of users, the percent composition, and the percent coverage for year to date.

Ad Performance

The TrendReporter allows the client to view previously generated reports, including charts. Clients can view the ads which relate to the data provided by the TrendReporter. Clients can view previously generated charts displaying data, as examples, in the following areas: brand recall, ad copy analysis, ratings comparison, ratings analysis, and network performance.

Reports may be run at specified times in the day. They compile all the required data and display the results in a HTML page. They allow the client to easily see the effectiveness of the ad campaign. The following are examples of reports that may be made accessible to clients:

RTV_Ad_Performance-Report_{—}1—Displays statistics for RewardTV vs. NTI Index, Recall Index, Top 2 Liking, and Qual Index based on the Network the Ad ran on for the time period of last night

RTV_Ad_Performance-Report_{—}2—Displays statistics for REWARDTV vs. NTI Index, Recall Index, Top 2 Liking, and Qual Index based on the ad copy the for the time period of last night

RTV_Ad_Performance-Report_{—}3—Displays statistics for REWARDTV vs. Index, Recall Index, Top 2 Liking, and Qual Index based on the Genre for the time period of last night.

RTV_Ad_Performance-Report_{—}4—Displays statistics for REWARDTV vs. NTI Index, Recall Index, Top 2 Liking, and Qual Index based on the Program for the time period of last night

RTV_Ad_Performance-Report_{—}5—Displays statistics for RewardTV vs. NTI Index, Recall Index, Top 2 Liking, and Qual Index based on the Network the Ad ran on for the time period of last week

RTV_Ad_Performance-Report_{—}6—Displays statistics for RewardTV vs. NTI Index, Recall Index, Top 2 Liking, and Qual Index based on the Ad copy the for the time period of last week.

RTV_Ad_Performance-Report_{—}7—Displays statistics for RewardTV vs. NTI Index, Recall Index, Top 2 Liking, and Qual Index based on the Genre for the time period of last week

RTV_Ad_Performance-Report_{—}8—Displays statistics for RewardTV vs. NTI Index, Recall Index, Top 2 Liking, and Qual Index based on the Program for the time period of last week.

RTV_Ad_Performance-Report_{—}9—Displays statistics for RewardTV vs. NTI Index, Recall Index, Top 2 Liking, and Qual Index based on the Network the Ad ran on for the time period of last month.

RTV_Ad_Performance-Report_{—}10—Displays statistics for RewardTV vs. NTI Index, Recall Index, Top 2 Liking, and Qual Index based on the Ad copy the for the time period of last month.

RTV_Ad_Performance-Report_{—}11—Displays statistics for RewardTV vs. NTI Index, Recall Index, Top 2 Liking, and Qual Index based on the Genre for the time period of last month.

RTV_Ad_Performance-Report_{—}12—Displays statistics for RewardTV vs. NTI Index, Recall Index, Top 2 Liking, and Qual Index on the Program for the time period of last month.

RTV_Ad_Performance-Report_{—}13—Displays statistics for RewardTV vs. NTI Index, Recall Index, Top 2 Liking, and Qual Index based on the Network the Ad ran on for the time period of year to date.

RTV_Ad_Performance-Report_{—}14—Displays statistics for RewardTV vs. NTI Index, Recall Index, Top 2 Liking, and Qual Index based on the Ad copy the for the time period of year to date.

RTV_Ad_Performance-Report_{—}15—Displays statistics for RewardTV vs. NTI Index, Recall Index, Top 2 Liking, and Qual Index based on the Genre for the time period of year to date.

RTV_Ad_Performance-Report_{—}16—Displays statistics for RewardTV vs. NTI Index, Recall Index, Top 2 Liking, and Qual Index based on the Program for the time period of year to date.

Last Night Ad Performance

The client site preferably includes a section which gives clients access to browse statistics about the number of users who took their test. This section expands to allow the advertiser to browse statistics by time period. The available time periods may include, for example:

RTV_Last_Night-Report_{—}1—Displays statistics for Nielsen A18-49 Rtg, RewardTV A18-49 Rtg, Avg. Ad Recall, Brand Recall, Recall Rtg, Top 2 box liking, and % favorites based on the Network the Ad ran on for the time period of last night

RTV_Last_Night-Report_{—}2—Displays statistics for Nielsen A18-49 Rtg, RewardTV™ A18-49 Rtg, Avg. Ad Recall, Brand Recall, Recall Rtg, Top 2 box liking, and % favorites based on the Ad copy the for the time period of last night

RTV_Last_Night-Report_{—}3—Displays statistics for Nielsen A18-49 Rtg, RewardTV™ A18-49 Rtg, Avg. Ad Recall, Brand Recall, Recall Rtg, Top 2 box liking, and % favorites based on the Genre for the time period of last night.

RTV_Last_Night-Report_{—}4—Displays statistics for Nielsen A18-49 Rtg, RewardTV™ A18-49 Rtg, Avg. Ad Recall, Brand Recall, Recall Rtg, Top 2 box liking, and % favorites based on the Program for the time period of last night

RTV_Last_Night-Report_{—}5—Displays statistics for Nielsen A18-49 Rtg, RewardTV™ A18-49 Rtg, Avg. Ad Recall, Brand Recall, Recall Rtg, Top 2 box liking, and % favorites based on the Network the Ad ran on for the time period of last week

RTV_Last_Night-Report_{—}6—Displays statistics for Nielsen A18-49 Rtg, RewardTV™ A18-49 Rtg, Avg. Ad Recall, Brand Recall, Recall Rtg, Top 2 box liking, and % favorites based on the Ad copy the for the time period of last week

RTV_Last_Night-Report_{—}7—Displays statistics for Nielsen A18-49 Rtg, RewardTV™ A18-49 Rtg, Avg. Ad Recall, Brand Recall, Recall Rtg, Top 2 box liking, and % favorites based on the Genre for the time period of last week

RTV_Last_Night-Report_{—}8—Displays statistics for Nielsen A18-49 Rtg, RewardTV™ A18-49 Rtg, Avg. Ad Recall, Brand Recall, Recall Rtg, Top 2 box liking, and % favorites based on the Program for the time period of last week

RTV_Last_Night-Report_{—}9—Displays statistics for Nielsen A18-49 Rtg, RewardTV™ A18-49 Rtg, Avg. Ad Recall, Brand Recall, Recall Rtg, Top 2 box liking, and % favorites based on the Network the Ad ran on for the time period of last month.

RTV_Last_Night-Report_{—}10—Displays statistics for Nielsen A18-49 Rtg, RewardTV™ A18-49 Rtg, Avg. Ad Recall, Brand Recall, Recall Rtg, Top 2 box liking, and % favorites based on the Ad copy the for the time period of last month.

RTV_Last_Night-Report_{—}11—Displays statistics for Nielsen A18-49 Rtg, RewardTV™ A18-49 Rtg, Avg. Ad Recall, Brand Recall, Recall Rtg, Top 2 box liking, and % favorites based on the Genre for the time period of last month.

RTV_Last_Night-Report_{—}12—Displays statistics for Nielsen A18-49 Rtg, RewardTV™ A18-49 Rtg, Avg. RewardTV™ Ad Recall, Brand Recall, Recall Rtg, Top 2 box liking, and % favorites based on the Program for the time period of last month.

RTV_Last_Night-Report_{—}13—Displays statistics for Nielsen A18-49 Rtg, RewardTV™ A18-49 Rtg, Avg. Ad Recall, Brand Recall, Recall Rtg, Top 2 box liking, and % favorites based on the Network the Ad ran on for the time period of year to date.

RTV_Last_Night-Report_{—}14—Displays statistics for Nielsen A18-49 Rtg, RewardTV™ A18-49 Rtg, Avg. Ad Recall, Brand Recall, Recall Rtg, Top 2 box liking, and % favorites based on the Ad copy the for the time period of year to date.

RTV_Last Night-Report_{—}15—Displays statistics for Nielsen A18-49 Rtg, RewardTV™ A18-49 Rtg, Avg. Ad Recall, Brand Recall, Recall Rtg, Top 2 box liking, and % favorites based on the Genre for the time period of year to date.

RTV_Last_Night-Report_{—}16—Displays statistics for Nielsen A18-49 Rtg, RewardTV™ A18-49 Rtg, Avg. Ad Recall, Brand Recall, Recall Rtg, Top 2 box liking, and % favorites based on the Program for the time period of year to date.

The system of the invention may be configured to run online ads to members while the members are recording their responses to earn credits. In this respect, the system offers advertisers the ability to run online ads to the same viewers who were exposed to their TV ads on an affiliated show. In addition, the system and method of the invention preferably allows advertisers to specifically target online advertising to individual members based on preference data, and utilize incentives and entertainment-based programs to increase purchase frequency among advertiser's core consumer groups.

A significant benefit of the invention is that it improves the audience viewing habits for an affiliated show, as it in effect pays people to watch. Audiences may become more loyal; that is, more likely to watch more frequently and consistently. Moreover, the reward system of the invention particularly benefits new shows—providing them with an alternative means to build audiences in the early weeks of the airing of the show, because a network can choose to provide more proprietary “currency” in connection with such shows and therefore provide more rewards for frequent and continuous viewing of such shows.

The system and method of the invention may be used to build a database of how consumers respond to all television ads so that advertisers can compare and contrast the results of their efforts with their competitors or prior campaigns. The data can be analyzed to determine how particular networks' programs are performing based on the level of attention and loyalty generated by viewers.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of conducting an incentivized trivia contest to increase the effectiveness of advertising, comprising:
storing in a computer system a first set of trivia questions relating to advertising;
storing in said computer system a second set of trivia questions relating to content;
associating said first and second sets of trivia questions with a broadcast of said advertising along with said content;
selecting a subset of said first and second trivia questions to ask a member;
transmitting said subset of trivia questions to said member and receiving said member's responses thereto via a communication medium;
scoring said member's performance in response to said subset of trivia questions; and,
providing incentives to said member based upon results of said scoring.

2. The method in accordance with claim 1, wherein said association of said first and second sets of trivia questions with a broadcast comprises storing data indicative of which advertising airs in conjunction with said broadcast.

3. The method in accordance with claim 1, wherein said broadcast comprises a television broadcast.

4. The method in accordance with claim 1, wherein said broadcast comprises a radio broadcast.

5. The method in accordance with claim 1, wherein said broadcast comprises a display of multimedia content via a network connection.

6. The method in accordance with claim 5, wherein said network connection comprises an internet connection.

7. The method in accordance with claim 1, wherein said communication medium comprises an internet connection.

8. The method in accordance with claim 1, wherein said communication medium comprises interactive television.

9. The method in accordance with claim 1, wherein said communication medium comprises a set-top box.

10. The method in accordance with claim 1, wherein said communication medium comprises a wireless device.

11. The method in accordance with claim 1, wherein said communication medium comprises a data network.

12. A method of using a user profile to conduct a trivia contest, comprising:
storing in a computer system a first set of trivia questions relating to advertising;
storing in said computer system a second set of trivia questions relating to content;
associating said first and second sets of trivia questions with a broadcast of said advertising along with said content;
storing in said computer system a demographic profile of at least one member;
using said demographic profile to select a subset of said first and second trivia questions to ask said member; and,
transmitting said subset of trivia questions to said member and receiving said member's responses thereto via a communication medium.

13. The method in accordance with claim 7, wherein said computer system comprises a plurality of computers interconnected via a network.

14. A method of determining advertising performance, comprising:
storing in a computer system a first set of trivia questions relating to advertising;
storing in said computer system a second set of trivia questions relating to content;
associating said first and second sets of trivia questions with a broadcast of said advertising along with said content;
selecting a subset of said first and second trivia questions to ask a member;
transmitting said subset of trivia questions to said member and receiving said member's responses thereto via a communication medium; and
determining advertising performance based upon said member's answers to said subset of trivia questions.

15. A method of determining the effectiveness of product placement, comprising:
storing in a computer system a first set of trivia questions relating to a product;
storing in said computer system a second set of trivia questions relating to content;
associating said first and second sets of trivia questions with a broadcast of said advertising along with said content;
selecting a subset of said first and second trivia questions to ask a member;
transmitting said subset of trivia questions to said member and receiving said member's responses thereto via a communication medium; and
determining the effectiveness of placement of said product within said content based upon said member's answers to said subset of trivia questions.

16. A method of creating a report indicative of the effectiveness of advertising, comprising:
storing in a computer system a first set of trivia questions relating to said advertising;
storing in said computer system a second set of trivia questions relating to content;
associating said first and second sets of trivia questions with a broadcast of said advertising along with said content;
transmitting said first and second sets of trivia questions to a member and receiving said member's responses thereto via a communication medium; and
using answers to said first and second sets of trivia questions to create a report indicative of effectiveness of said advertising.

17. The method of creating a report in accordance with claim 11, wherein said step of creating a report further comprises using a plurality of demographic profiles to create said report.

18. The method in accordance with claim 11 wherein said advertising comprises a commercial.

19. The method in accordance with claim 11 wherein said advertising comprises placement of a product within said content.

20. A method of conducting an incentivized trivia contest to increase the effectiveness of advertising, determine advertising performance, and determine content performance, comprising:
storing in a computer system a first set of trivia questions relating to advertising;
storing in said computer system a second set of trivia questions relating to content;
storing in said computer system a demographic profile of at least one member;
associating said first and second sets of trivia questions with a broadcast of said advertising along with said content;
using said demographic profile to select a subset of said first and second trivia questions to ask a member who has received said broadcast;
transmitting said subset of trivia questions to said member and receiving said member's responses thereto via a communication medium;
scoring said member's performance in response to said subset of trivia questions;
providing incentives to said member based upon results of said scoring; and,
using answers to said first and second sets of trivia questions to create a report indicative of effectiveness of said advertising.

21. A method of creating a report indicative of recall, understanding, likeability or other broadcast performance measure, comprising:
storing in a computer system a set of trivia questions relating to the content of a broadcast;
associating said trivia questions with a broadcast of said content;
transmitting said set of trivia questions to a member and receiving said member's responses thereto via a communication medium;
scoring said member's performance in response to said subset of trivia questions;
providing incentives to said member based upon results of said scoring; using said responses to said set of trivia questions to create a report indicative of at least one broadcast performance factor;
transmitting said report to a client.

22. The method in accordance with claim 16, wherein said broadcast performance factor comprises recall.

23. The method in accordance with claim 16, wherein said broadcast performance factor comprises understanding.

24. The method in accordance with claim 16, wherein said broadcast performance factor comprises likeability.

25. A method of conducting an incentivized trivia contest to increase the effectiveness of advertising, comprising:
storing in a computer system a set of trivia questions relating to advertising;
associating said set of trivia questions with a time period of a broadcast of said advertising;
transmitting said set of trivia questions to said member and receiving said member's responses thereto via a communication medium;
scoring said member's performance in response to said set of trivia questions; and,
providing incentives to said member based upon results of said scoring.
